(19) United States
(12) Patent Application Publication
(10) Pub. No.: US 2004/0226894 A1
(43) Pub. Date: Nov. 18, 2004

(54) Method of preparing a sterile water containing hypochlorous or chlorous acid, package of sterile source materials, and sterile water preparation kit

(76) Inventor: Tatsuo Okazaki, Kamifukuoka-shi (JP)

Correspondence Address: KILYK & BOWERSOX, P.L.L.C., 53 A EAST LEE STREET, WARRENTON, VA, 20186, US

(21) Appl. No.: 10/730,159

(22) Filed: Dec. 8, 2003

(30) Foreign Application Priority Data
May 12, 2003 (JP) 2003-132971
Aug. 28, 2003 (JP) 2003-345020
Oct. 31, 2003 (JP) 2003-371518

(51) Int. Cl. C02F 1/76

(52) U.S. Cl. 210/756

(57) ABSTRACT

The upper end of a cylinder (8) located in a mouth (3) of a bottle (2) abuts the top plate (5b) of a seal cap (5). The cylinder (8) has formed in the outer surface thereof a circumferential recess (10) normally sealed by a sealing member (9). The bottle (2) contains hydrochloric acid (second component) having a diluted concentration, while the circumferential recess (10) in the cylinder (8) contains sodium hypochlorite (first component). When a stopper ring (6) is removed and the seal cap (5) is turned in the tightening direction, the circumferential recess (10) moves to below the sealing member (9) and the first component is permitted to flow into the bottle (2) and produce a sterile water. The resulting sterile water has a pH level within the slightly acidic or neutral region and a predetermined effective chlorine concentration around 50 to 300 ppm, for example.

### FIELD OF THE INVENTION

This invention generally relates to sterilization using hypochlorous or chlorous acid, and more particularly, to a method of preparing a sterile water containing hypochlorous or chlorous acid, a package of sterile source materials, and a sterile water preparation kit.

### BACKGROUND OF THE INVENTION

As one of and easy ways of using a sterile liquid, there have been commercially available portable canned alcohol-diluted sterile liquids charged in portable cans together with compressed or liquefied gases. The cans are typically equipped with a spray nozzle, and spray the contained sterile liquid when the spray nozzle is depressed. Therefore, the canned sterile liquids of this type are convenient for easy sterilization. However, they cannot be used for sterilization of food.

On the other hand, sterile sprays for sterilization by disinfectant alcohol are widely used especially in the medical and clinical field including hospitals. However, since alcohol-based sterile liquids roughen skins, they are not so welcomed by users, especially, feminine users. Additionally, sterilization by disinfectant alcohol may invite development of resistant bacteria.

Sterilization by hypochlorous acid (HClO) or chlorous acid (HClO₂) has been known as a method overcoming the above problems. This method has various advantages, namely, wide coverage of sterilization from viruses to bacillus and anthracis, instantaneous sterilizing effect to them, and no development of resistant bacteria. Especially, sterile water containing hypochlorous or chlorous acid, if conditioned in the slightly acidic region, has the excellent advantage of not roughening skins and not causing allergic reaction. The safety of the sterile water containing hypochlorous acid to human bodies is apparent also from the fact that hypochlorous acid is generated in living bodies by neutrophilic leucocytes (also called polymorphonuclear leucocytes) and takes charge of internal sterilization. Therefore, sterilization by hypochlorous acid must be the most desirable method of sterilization among currently known various methods from the viewpoint of sterilizing power and nontoxicity to human bodies.

Sterilization by hypochlorous or chlorous acid, however, involves some problems to be overcome. One of the problems is deterioration of its sterilizing power with time. Another problem is generation of toxic gas, depending upon the pH level. These problems are explained below in greater detail.

As already known, hypochlorous acid, for example, can exist only in form of water solution of hypochlorite, such as sodium hypochlorite, appropriately adjusted in pH. In general, sodium hypochlorite is shipped from manufacturers in form of water solution adjusted in concentration to 6% or 12%. This solution is originally alkaline, and contains elements, H, O and Cl of hypochlorous acid relatively stably in form of ions H⁺ and OCl⁻. In this form, water solution of sodium hypochlorite is not effective as sterile water. When adjusted in pH within the neutral or slightly acidic region, water solution of sodium hypochlorite can contain hypochlorous acid (HOCl) by a higher ratio, and is effective as HOCl sterile water. FIG. 42 is a graph extracted from page 104 of the book entitled “Josuino Gijutsu (Water-purifying Technology)”, published from Gihodo. FIG. 42 shows that OCl⁻ ions require the time as much as 80 times that of HOCl (hypochlorous acid) to sterilize 99% of coliform bacteria. In other words, FIG. 42 demonstrates that the sterilizing power of hypochlorous acid is 80 times that of OCl⁻ ions.

Therefore, to obtain HOCl-rich sterile water, it is very important to adjust the pH level of the water solution of sodium hypochlorite by adding an acid such as hydrochloric acid (HCl). However, if the added quantity of the acid is excessive, water solution of sodium hypochlorite becomes acidic, and generates toxic chlorine gas.

Furthermore, even when the water solution is once adequately adjusted in pH level to contain a sufficient concentration of hypochlorous acid (HOCl), the pH level is liable to shift with time, and hypochlorous acid cannot maintain its form for a long time.

That is, there are the following balancing relations among three chemical seeds Cl₂, HOCl, OCl³¹.

Cl₂+H₂O⇄HCl+HOCl (1)

HOCl⇄H⁺+OCl⁻ (2)

where left terms are lower in pH level and right terms are higher in pH level.

As mentioned above, existential ratios of individual chemical seeds are governed by pH. The lower the pH, the higher the ratio of gaseous chlorine (Cl₂) as understood from the chemical formula (1). In the slightly acidic and neutral regions, the ratio of hypochlorous acid (HOCl) is higher (chemical formula (1)). In the alkaline region, hypochlorous acid (HOCl) is decomposed into H⁺ and OCl⁻ ions, and the ratio of ions OCl⁻ becomes higher (chemical formula (2)).

Therefore, for effective sterilization, it is apparently desirable to use fresh and HOCl-rich sterile water properly adjusted in pH level, but it must be ensured that users are not subjected to toxic gas.

Sodium chlorite produces gaseous chlorine dioxide (ClO₂). Gaseous chlorine and chlorine dioxide are both toxic gases. Especially, gaseous chlorine dioxide exhibits toxicity 10 times higher than that of gaseous chlorine.

Heretofore, it has been the common knowledge that users' manipulation of mixing an acid to water solution of sodium hypochlorite should be prohibited. For example, Kao, Ltd. (Tokyo, Japan) sells a household bleaching/sterile solution under the brand name of “WHITER” targeted to the consuming public. This solution contains sodium hypochlorite as its major component, and its container bears red-printed cautions “DANGER! Never mix” and “If you use it together with acid things, gaseous chlorine will develop, which is dangerous” to call users' attention.

Japanese Patent Laid-open Publication JP2003-34375A proposes a portable sterile container within the above-discussed common knowledge. This is a can-shaped container charged with ready-to-use sterile water already adjusted in pH level in the range from 4 to 8 and in residual chlorine concentration in the range from 10 to 2,000 ppm by adding an acid such as hydrochloric acid to sodium hypochlorite together with a compressed or liquefied gas. The can-shaped container includes a spray nozzle. When the spray nozzle is depressed, the container sprays the sterile water with the aid of the gas pressure. However, the canned sterile water in this prior art cannot ensure the user to use sufficiently powerful sterile water whenever he/she needs it because the sterile water deteriorates in sterilizing power with time as discussed before.

On this account, sterile water generators designed for installation in the site of actual use are commercially available. FIG. 43 shows a conventional sterile water generator. The sterile water generator is designed to prepare a sterile water having an effective chlorine concentration in the range from 50 to 200 ppm in the slightly acidic or neutral region by performing dilution of sodium hypochlorite with water and dilution of hydrochloric acid with water in the first step and thereafter mixing the diluted liquids in the second step. These sterile water generators are useful to obtain fresh preparation of the desirable sterile water any time. However, they are too expensive for the consuming public to purchase for their own use. Therefore, these sterile water generators are currently used only in limited places including hospitals and factories, which need to clean and sterilize vegetables and meats in bulk or need to clean and sterilize many machines, tools or appliances very often.

### SUMMARY OF THE INVENTION

The present invention was worked out by the Inventor thereof with his inspiration that users may be allowed to make a sterile water by mixing components (substances mixed together to produce the sterile water will be referred to as “components” hereinafter) by themselves if the mixing will not develop any toxic gas. This inspiration is a great jump out of the common belief of those skilled in the art.

It is therefore an object of the present invention to provide a method of preparing a sterile water adjusted in pH within the slightly acidic or neutral region, a package of sterile source materials and a sterile water preparation kit, which enable on-site easy preparation of fresh sterile water and powerful sterilization with hypochlorous or chlorous acid whenever and wherever necessary without machineries.

Another object of the invention is to provide an easy-to-carry package of sterile source materials, which is suitable for on-site easy preparation of fresh sterile water and powerful sterilization with hypochlorous or chlorous acid any time in any location.

Another object of the invention is to provide a package of sterile source materials and a sterile water preparation kit, which can be stored for a long period and enable on-site easy preparation of fresh sterile water and powerful sterilization with hypochlorous or chlorous acid any time in any location.

Typical source materials applicable to the present invention are hypochlorites and chlorites including sodium hypochlorite, sodium chlorite and calcium hypochlorite. Sodium hypochlorite is available also in a crystalline form, but it is easier to obtain it typically in form of 6% (60,000 ppm) or 12% (120,000 ppm) water solution that is available from manufacturers. Calcium hypochlorite is available typically in form of powder from manufacturers.

In the following explanation of the invention, any hypochlorite (chlorite) in a direct solution form obtained from a manufacturer will be referred to as the solution of an “undiluted concentration” or the “undiluted solution), whereas a solution diluted by adding water to the concentrated solution from a manufacturer will be referred to as the solution of a “diluted concentration” or the “diluted solution”.

Other materials applicable to the invention are acids such as hydrochloric acid, for example. Other applicable acids include inorganic acids such as sulfuric acid, carbonic acid and the like, and organic acids such as acetic acid, and the like. In the following explanation, any of these acids having the concentration directly from a manufacturer will be referred to as an acid of an “undiluted concentration” or as an “undiluted acid” whereas a liquid thereof diluted by adding water to the concentrated acid will be referred to as an acid of “diluted concentration” or a “diluted acid”. Hydrochloric acid, for example, is available in form of 36% solution for industrial use and in form of solution of 10% or even lower concentration for household purposes from manufacturers. Thus, the direct solution of hydrochloric acid from a manufacturer will be referred to as “undiluted acid”, whereas a solution diluted by adding water to the undiluted acid will be referred to as “diluted acid”.

According to the first aspect of the invention, a first container containing hypochlorite (chlorite) (referred to as “first component” hereunder) and a second container containing an acid (referred to as “second component” hereunder) are provided in combination for use by a consumer. The first and second components are conditioned to ensure that the sterile water prepared by a consumer by mixing the first and second components (as shown in FIG. 2) will have a pH level in the weak-acid or neutral region and a predetermined effective concentration of chlorine.

In one mode of preparation of the sterile water, the first container contains the first component in undiluted, solid (typically powder) or diluted form whereas the second container contains the second component in a diluted form (FIG. 1). In another mode of preparation of the sterile water, the first container contains the first component of a diluted concentration whereas the second container contains the second component of an undiluted or diluted concentration (FIG. 2).

According to the second aspect of the invention, a first container containing a first component, a second container containing a second component and a third container containing a predetermined volume of water are provided in combination for use by a consumer. The first and second components are conditioned and the water in the third container is adjusted in quantity to ensure that the sterile water prepared by a consumer by mixing the first and second components to the water, as shown in FIG. 3, has a pH level in the weak-acid or neutral region and a predetermined effective concentration of chlorine.

According to the third aspect of the invention, a first container containing a first component, a second container containing a second component and a manual having instructions for mixture of the first and second components are provided in combination for use by a consumer. The first and second components are conditioned to ensure that the sterile water prepared by a consumer by mixing the first and second components to an instructed quantity of water according to the instructions on the manual will have a pH level in the weak-acid or neutral region and a predetermined effective concentration of chlorine.

In the second and third aspects of the invention, the first container containing the first component in an undiluted, solid (typically powder) or diluted form and the second container containing the second component of an undiluted or diluted concentration are provided in combination for use by a consumer.

For direct use to an affected part of an atopic patient, the first and second components are preferably conditioned to ensure that the effective chlorine concentration of the sterile water prepared according to the invention will be about 30 ppm. For ordinary users, however, the first and second components are preferably conditioned to ensure that the effective chlorine concentration of the sterile water will be about 50 through 300 ppm with an allowance. For military forces especially in frontline bases, the first and second components are preferably conditioned to ensure that the effective chlorine concentration of the sterile water will be about 50 through 1000 ppm. The sterile water prepared according to the invention may be diluted by water. In this case, the first and second components are preferably conditioned to ensure that the effective chlorine concentration of the sterile water prepared according to the invention is about 50 through 60,000 ppm, preferably 50 to 10,000 ppm, more preferably 50 to 2,000 ppm, or most preferably 50 to 1,000 ppm, taking spatial sterilization into account. The effective chlorine concentration is substantially synonymous with the concentration of free chlorine.

In case the first component is supplied in a liquid form to a consumer, more specifically, in case that sodium hypochlorite is supplied in form of a diluted form as low as 2,000 ppm or less to a consumer, it is preferably supplied after being adjusted in pH level to 10 or higher by adding an alkali (NaOH, for example). Since the sodium hypochlorite is relatively stable in an alkaline region of more than pH10, adjustment of the pH level to higher than pH10 with an alkali adjusting liquid contributes to delaying the decrease of the sterilizing power of the sodium hypochlorite with time. In other words, for supply of the sodium hypochlorite in a relatively high concentration of, for example, about 10,000 ppm (1%) to the user, it is not necessary in general to add any alkali to the sodium hypochlorite because sodium hypochlorite of such a relatively high concentration is high alkali containing sodium hydroxide (NaOH). However, for use in military or other special sites, where long-term storage in a high-temperature atmosphere, for example, is expected, the alkali adjusting liquid may be added to the first component to adjust the pH level to a strong alkaline level (for example, around pH 13).

For users who will use the sterile water for sterilization of hands, sodium chloride (NaCl) may be added to the first or second component, for example, so that the prepared sterile water will have a concentration nearly equal to that of the physiologic saline solution. Similarly, for users who use the sterile water for sterilization and cleansing, a surface-active agent may be added to the first or second component, or to water for dilution, so that the prepared sterile water will contain the surface-active agent.

In a typical embodiment of the invention, a self-standing or flexible outer container housing an inner container is prepared, and it is supplied to consumers, with the first and second components contained in the inner and outer containers, respectively. The user having this product will conduct intentional manipulation to mix the first or second component in the inner container to the second or first component in the outer container, for example.

Examples of intentional manipulation for mixing the component in the inner container with that in the outer container are as follows.

In one mode of mixture, the inner container is dropped into and opened to the component in the outer container to permit the component in the inner container to mix with that in the outer container.

In another mode of mixture, the inner container housed in the outer container is forcibly brought into communication with the outer container to permit the component in the inner container to mix with that in the outer container.

In another way of mixture, a strong force is applied to the outer container to break a hole, or the like, in the inner container inside the outer container, and permit the component in the inner container to mix with that in the outer container through the hole.

The container of the sterile water preparation kit or the package of sterile source materials according to the invention may be supplied together with a spray nozzle as an attachment of the container, or may include a spray nozzle attached beforehand to a seal cap of the container.

Like the conventional sterile water, the sterile water prepared by using the sterile water preparation kit or the package of sterile source materials according to the invention is usable for cleansing or sterilizing a large volume of foods such as vegetables and meats, and for spatial sterilization of hospitals or other facilities. Therefore, it will be unnecessary to install expensive sterile water preparation equipments.

The sterile water preparation kit or the package of sterile source materials according to the invention can be stocked in military forces, hospitals or private houses and can be used to prepare fresh sterile water whenever necessary. Further, if women carry the package of sterile source materials according to the present invention in their handbags, for example, they can prepare fresh sterile water whenever and wherever necessary to use it for sterilization by hypochlorous (chlorous) acid.

These and other objects, features and advantages of the present invention will become more apparent from the detailed description of the preferred embodiments of the invention, which follow herein below.

### BRIEF DESCRIPTION OF THE DRAWINGS

FIG. 1 is a diagram for explaining one example included in the basic concept of the present invention;

FIG. 2 is a diagram for explaining another example included in the basic concept of the present invention;

FIG. 3 is a diagram for explaining still another example included in the basic concept of the present invention;

FIG. 4 is a partial sectional view of a package of sterile source materials according to the first embodiment of the invention;

FIG. 5 is a diagram showing the substantial portion of the package of sterile source materials according to the first embodiment shown in FIG. 4 in an enlarged scale;

FIG. 6 is a diagram showing the substantial part of a modification of the first embodiment in an enlarged scale;

FIG. 7 is a diagram showing the substantial part of another modification of the first embodiment in an enlarged scale;

FIG. 8 is a diagram showing the substantial part of still another modification of the first embodiment in an enlarged scale;

FIG. 9 is a diagram showing the substantial part of yet another modification of the first embodiment in an enlarged scale, with a circumferential recess of a cylindrical member containing the first component being sealed;

FIG. 10 is a diagram related to FIG. 9 and showing the circumferential recess of the cylindrical member containing the first component is exposed to the inner space of a bottle;

FIG. 11 is a diagram showing the substantial part of yet another modification of the first embodiment in an enlarged scale;

FIG. 12 is a diagram showing a package of sterile source materials according to the second embodiment of the invention, in which the top portion of the inner container is being cut by a cutting-aid element built in the container;

FIG. 13 is a diagram showing the substantial portion of the package of sterile source materials shown in FIG. 12 for explaining that the cutting-aid element is built in the container with the blade thereof facing upward in storage of the container;

FIG. 14 is a diagram showing a modification of the second embodiment shown in FIG. 12;

FIG. 15 is a diagram showing a package of sterile source materials according to the second embodiment, in which the bottom portion of the inner container is being cut by an elongated cutting blade built in the inner container;

FIG. 16 is a diagram showing the substantial part of FIG. 15 in an enlarged scale to show the aspect of the package of sterile source materials in storage;

FIG. 17 is a diagram showing a package of sterile source materials according to the third embodiment;

FIG. 18 is a diagram showing a package of sterile source materials according to the fourth embodiment;

FIG. 19 is a diagram showing a modification of the fourth embodiment;

FIG. 20 is a diagram showing a package of sterile source materials according to the fifth embodiment;

FIG. 21 is a diagram showing a package of sterile source materials according to the sixth embodiment;

FIG. 22 is a cross-sectional view of a substantial part of a package of sterile source materials according to the sixth embodiment, taken from the arrow mark X22 of FIG. 21;

FIG. 23 is a diagram showing a package of sterile source materials according to the seventh embodiment;

FIG. 24 is an enlarged view of a substantial part of the package of sterile source materials of FIG. 23;

FIG. 25 is a sterile water preparation kit taken as the eighth embodiment;

FIG. 26 is a diagram showing a sterile water preparation kit as a modification of the eighth embodiment;

FIG. 27 is a diagram showing a sterile water preparation kit as another modification of the eighth embodiment;

FIG. 28 is a diagram showing a sterile water preparation kit as still another modification of the eighth embodiment;

FIG. 29 is a diagram showing a way of spraying sterile water prepared in a package of sterile source materials according to an embodiment of the present invention by attaching a sprayer to the package;

FIG. 30 is a diagram showing a way of spraying sterile water prepared in a package of sterile source materials according to an embodiment of the present invention by attaching another type of sprayer to the package;

FIG. 31 is a perspective view of a mixture promoter adapted for the sterile water outlet of the sprayer shown in FIG. 30;

FIG. 32 is an enlarged cross-sectional view of the sterile water outlet of the sprayer shown in FIG. 30;

FIG. 33 is a diagram for explaining a way of sterilizing a wound with the package of sterile source materials having the sprayer shown in FIG. 30;

FIG. 34 is a diagram showing a spatial sterilization apparatus suitable for spatial sterilization with sterile water prepared by using a package of sterile source materials or a sterile water preparation kit according to the present invention;

FIG. 35 is a diagram showing a modification of the spatial sterilization apparatus shown in FIG. 34, which is in use in the mode of supplying sterile water from a cartridge tank;

FIG. 36 is a diagram showing the same modification of the spatial sterilization apparatus shown in FIG. 34, which is, however, in use in the mode of supplying sterile water through a pipe arrangement;

FIG. 37 is a diagram showing a modification of the bottle containing an inner container;

FIG. 38 is a diagram showing another modification of the bottle containing an inner container;

FIG. 39 is a diagram showing still another modification of the bottle containing an inner container;

FIG. 40 is a diagram showing yet another modification of the bottle containing an inner container;

FIG. 41 is a diagram showing a modification of the bottle shown in FIG. 40;

FIG. 42 is a diagram showing powerful sterile power of hypochlorous acid; and

FIG. 43 is a diagram showing procedures for preparation of sterile water by a conventional sterile water generator.

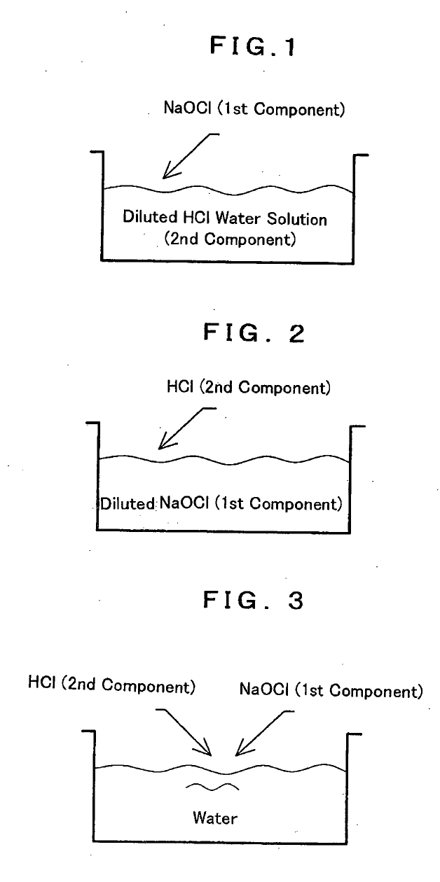

### DETAILED DESCRIPTION OF THE INVENTION

Before starting detailed description of preferred embodiments of packages according to the invention, their general aspects are explained below.

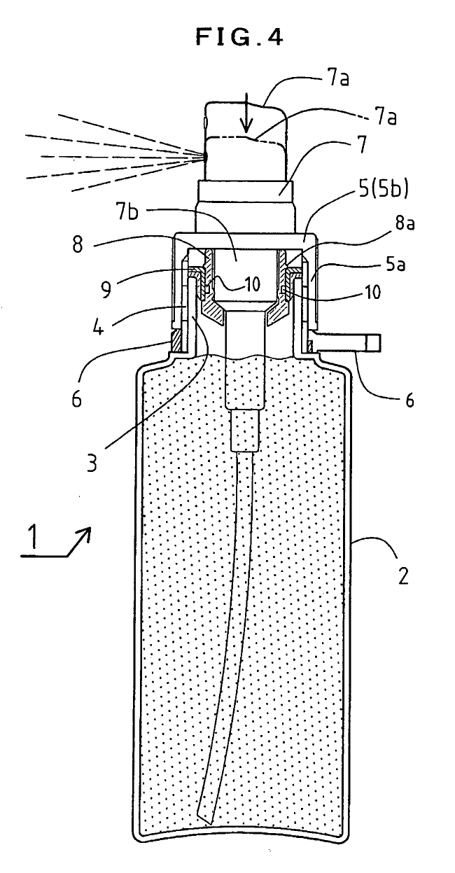

As shown in FIGS. 4 to 16, 18 to 19 or 21 to 24, a preferred embodiment of the invention is a package of sterile source materials comprising

a first component containing a hypochlorite or chlorite;

a second component containing an acid;

a single container holding the first component and the second component separately with a partition; and

a movable element that can move under an intentional force applied from outside the container,

wherein movement of the movable member permits the first component and the second component to merge and produce sterile water in the container, and

wherein the first component and the second component are conditioned so that the sterile water produced by mixture thereof has a predetermined effective concentration of chlorine and a pH level within the slightly acidic or neutral region.

As shown in FIGS. 4 to 11 or FIG. 23, a more specific embodiment of the invention is a package of sterile source materials comprising:

an outer container holding one of a first component containing a hypochlorite or chlorite and a second component containing an acid;

an inner container housed in the first container and holding the other of the first and second components;

a sealing member which seals the inner container; and

an operation member provided in association with the outer container and accessible from outside the outer container,

wherein manipulation of the operation member frees the inner container from the sealing member and permits the other component in the inner container to flow out into the outer container and produce a sterile water; and

wherein the first and second components are conditioned so that the sterile water produced by mixture thereof has a predetermined effective concentration of chlorine and a pH level within the slightly acidic or neutral region.

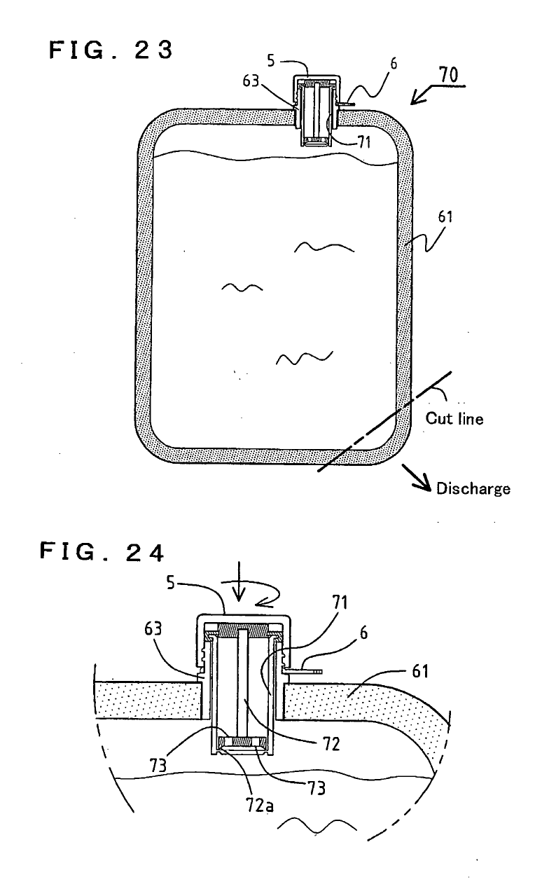

In the embodiment shown in FIG. 4, the operation member comprises a sealing cap of the outer container, and may be a pusher exposed externally as explained later as a modification shown in FIG. 18 or 19, for example. The inner container may be provided in the mouth area of the outer container as shown in FIG. 23.

The inner container may be designed to drop inside the outer container when it is freed from the sealing member. For this purpose, the inner container may have a weight.

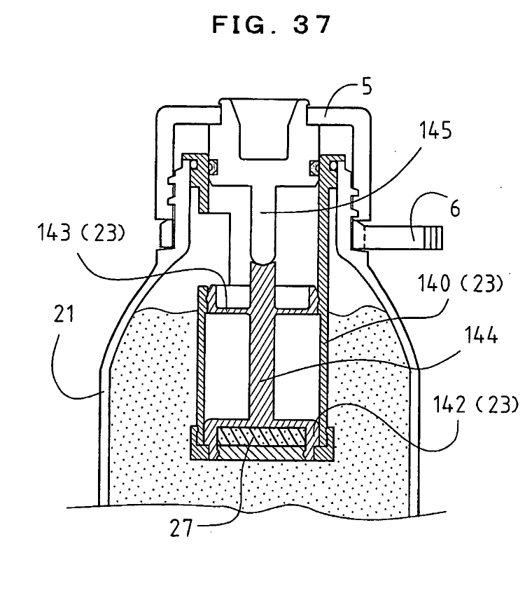

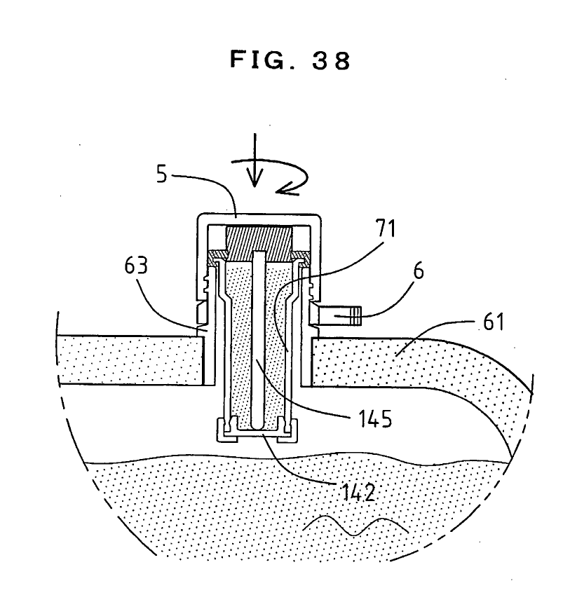

As shown in FIGS. 37 and 38, a more specific embodiment of the invention is a package of sterile source materials comprising:

an outer container holding one of a first component containing a hypochlorite or chlorite and a second component containing an acid;

an inner container housed in the first container and holding the other of the first and second components;

a plug in close fitting in an opening formed in the inner container to communicate with the inner space of the outer container; and

an operation member provided in association with the outer container and accessible from outside the outer container,

wherein intentional manipulation of the operation member causes the plug to slip out of the opening of the inner container and thereby permit the other component to flow out of the inner container into the outer container to generate sterile water; and

wherein the first and second components are conditioned to assure that the sterile water produced by mixture thereof has a predetermined effective concentration of chlorine and a pH within a slightly acidic or neutral region.

These and other embodiments of the invention will now be explained below with reference to the drawings.

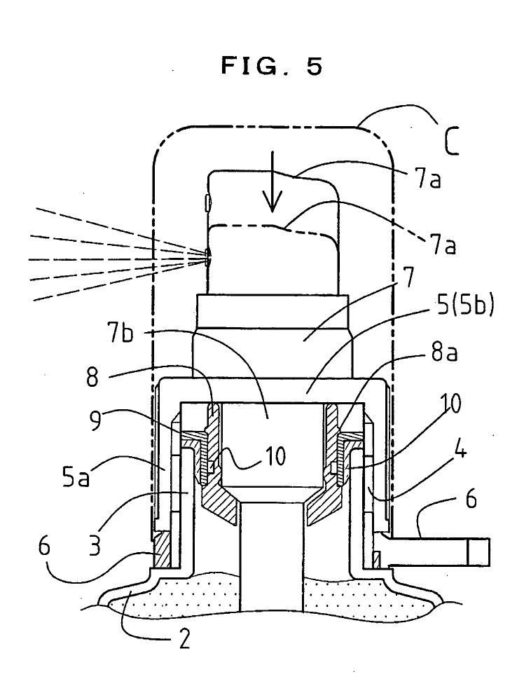

### FIRST EMBODIMENT (FIGS. 4 AND 5)

A package of sterile source materials 1 includes a portable self-standing bottle 2 made of a chemical-resistant plastic material. The bottle 2 has a cylindrical shape having a diameter easy for a user to hold the bottle in one hand, and its internal volume is approximately 100 cc. The bottle 2 is preferably made of a light-blocking material.

Especially with reference to FIG. 5, the bottle 2 has a mouth 3 formed at the top thereof to open upward and having a circular section. The bottle mouth 3 has a thread 4 on the outer surface thereof. The thread 4 is used to firmly hold a sealing cap 5 screwed thereon. The seal cap 5 is made of a plastic material, and has a stopper ring 6, preferably integral, at the lower end of a skirt portion 5a thereof. The stopper ring 6 extends along the entire circumference of the bottle mouth 3, and functions as a stopper or a spacer. It is also acceptable to form the stopper ring 6 as a separate member independent from the skirt portion 5a of the seal cap 5.

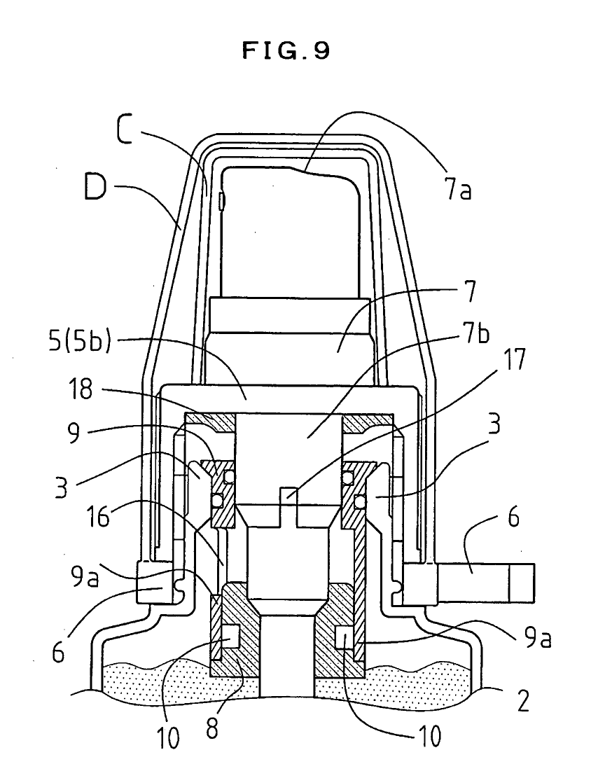

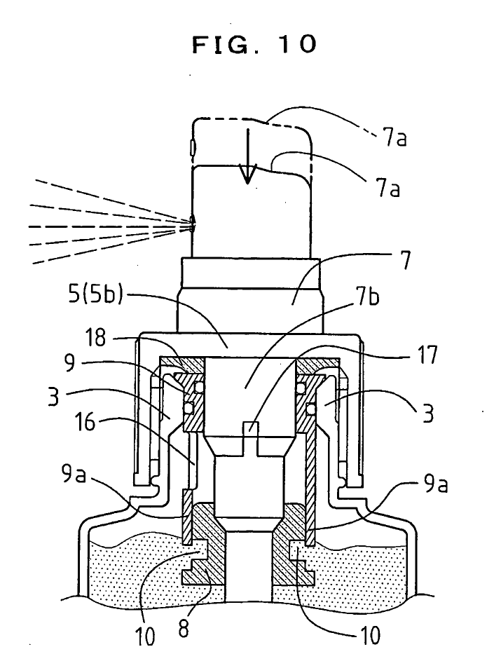

The seal cap 5 has a spray nozzle 7 mounted thereon. When a head 7a of the spray nozzle 7 is depressed in the arrow-marked direction, the spray nozzle 7 can spray the liquid contained in the bottle 2. The spray nozzle 7 of this type is well known, so its details are not explained herein. When the package 1 equipped with the spray nozzle 7 is shipped, the spray nozzle 7 may be covered with a protective cap C as shown in FIG. 5, or the spray nozzle 7 having the protective cap may be covered with a resin band D (FIG. 9). In this case, the stopper ring 6 may be formed as an integral part of the resin band D (FIG. 9).

The spray nozzle 7 has a nozzle body 7b positioned in the bottle mouth 3. A cylindrical member 8 is brought into close fitting on the nozzle body 7b, and the top end of the cylindrical member 8 abuts the top plate 5b of the seal cap 5. The cylindrical member 8 has formed on the outer surface thereof a circumferential projection 8a for engagement with the top edge of a sealing member 9 around the cylindrical member 8. Additionally, the cylindrical member 8 has formed in the outer surface thereof a pocket or circumferential recess 10 that is sealed by the sealing member 9 unless the stopper ring 6 is removed. That is, the circumferential recess 10 defines, inside the bottle 2, an inner space sealed by the sealing member 9.

The bottle 2 may package either the first component or the second component. In this embodiment, the bottle 2 packages therein a diluted hydrochloric acid (second component), and the circumferential recess 10 in the cylindrical member 8 contains sodium hypochlorite of an undiluted or diluted concentration as the first component.

The package of sterile source materials 1 according to the first embodiment is intended for use by a user by removing the stopper ring 6 from the bottom of the seal cap 5, next turning the seal cap 5 in the tightening direction. Thereby, the seal cap 5 can move down as much as the gap produced by removal of the stopper ring 6.

Once the seal cap 5 is moved down, the cylinder 8 is pressed down by the top plate 5b of the seal cap 5. As a result, the circumferential projection 8a on the cylinder 8 enters into the sealing member 9, and simultaneously, the circumferential recess 10 moves to below the sealing member 9 to be exposed in the inner space of the bottle 2. Thus, the first component in the circumferential recess 10 flows into the bottle 2.

Thereafter, the user can prepare 100 cc of sterile water by shaking the bottle 2 to mix the liquids in the bottle 2. The prepared sterile water will have a pH level in the slightly acidic or neutral region. The effective chlorine concentration is typically an arbitrary concentration in the range of 50 to 300 ppm approximately. In other words, the second component held in the bottle 2 and the first component held in the circumferential recess 10 are conditioned in quantity and concentration beforehand to ensure that the sterile water obtained by mixture of them has a pH level in a slightly acidic or neutral region and an effective chlorine concentration of an arbitrary value in the range of about 50 to 300 ppm approximately. If the package 1 is intended for use in military forces, for example, the first and second components may be conditioned to adjust its effective chlorine concentration to 800 ppm approximately.

If the package of sterile source materials 1 according to the first embodiment is manufactured for use by feminine users or for household use, sodium chloride (NaCl) may be added into the bottle 2, for example, so that the prepared sterile water has a concentration equivalent to that of physiologic saline (about 0.9%). If a feminine user having purchased the package 1 carries it with her in her handbag, for example, she will be able to conduct powerful sterilization by hypochlorous acid whenever and wherever she needs it. If the package 1 is manufactured for household use, a surface-active agent may be added to the bottle 2 in the manufacturing process to facilitate removal of oil or fat from eating utensils while sterilizing them.

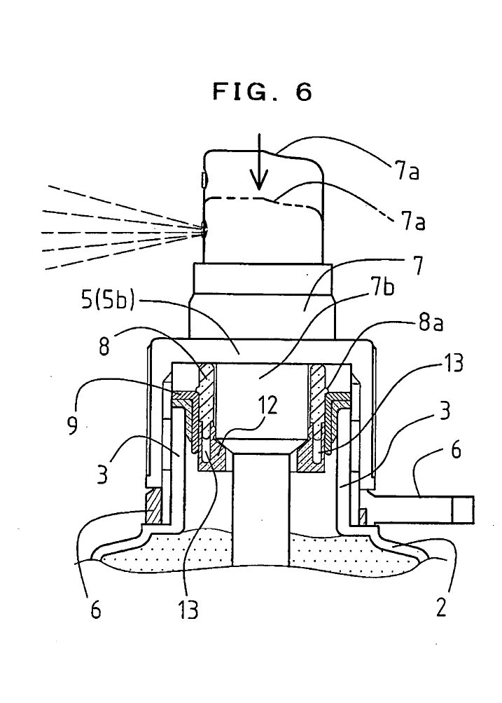

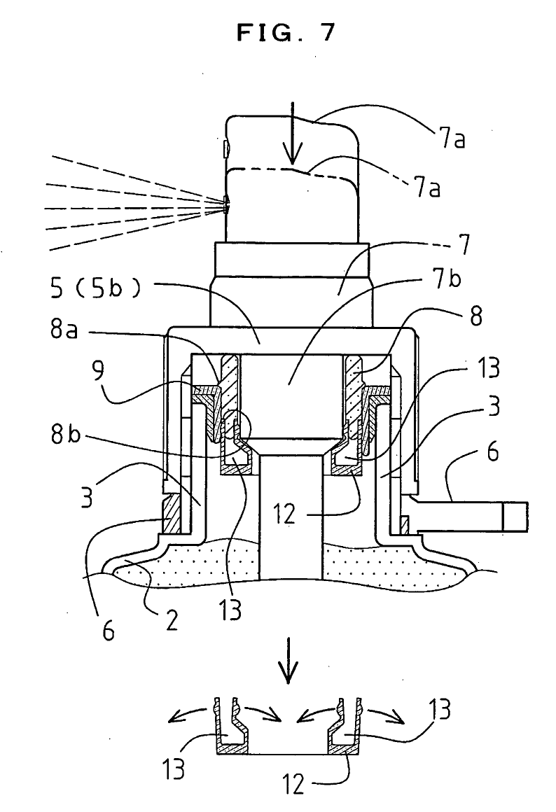

### MODIFICATIONS OF THE FIRST EMBODIMENT (FIGS. 6 TO 11)

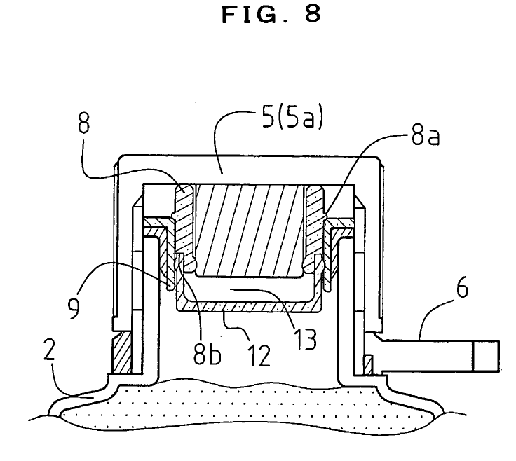

In the package of sterile source materials 1 according to the first embodiment explained above, the circumferential recess 10 on the cylinder 8 defines a sealed inner space inside the bottle 2. However, as shown in FIGS. 6 to 8, the first embodiment may be modified by using a separate-piece additional member 12 in close fitting with the bottom end of the cylindrical member 8 to define a space 13 between the additional member 12 and the bottom end of the cylindrical member 8. In these modifications, once a user removes the stopper ring 6 and next turns the seal cap 5 in the tightening direction, the cylinder 8 is pushed down by the top plate 5b of the seal cap 5. Then, the additional member 12 is pushed down by a shoulder portion 8b (see FIG. 7 or 8) at the lower end portion of the cylinder 8, and the additional member 12 is freed from the sealing member 9. As a result, the additional member 12 falls into the bottle 2, and the component heretofore held in the additional member 12 flows out into the bottle 2. In this case, the user is recommended to shake the bottle 2 to promote the mixture of the contents.

The lower diagram of FIG. 7 shows the aspect of the additional member 12 after falling.

The modifications in FIGS. 6 to 8 are substantially identical except the shape of the additional member 12. As apparent from comparison of FIGS. 6 through 8, the additional member 12 shown in FIG. 7 is larger in internal volume of the inner space 13 than that of FIG. 6, and the additional member 12 shown in FIG. 8 is larger in internal volume of the inner space 13 than that of FIG. 7. When the additional member 12 large in internal volume of the inner space 13 is employed, it is possible to hold the second component such as hydrochloric acid (HCl) in a sufficiently diluted form in the inner space 13 while packaging the first component in the bottle 2. In the modification shown in FIG. 8, the seal cap 5 does not has an incorporated spray nozzle, and the additional member 12 defines a cup-shaped inner space 13.

In the modifications shown in FIGS. 9 and 10, the sealing member 9 positioned in the bottle mouth 3 is extended downward. The sealing member 9 has an opening 16 at a vertically intermediate position so that the lower part 9a thereof with respect to the opening 16 seals the circumferential recess 10 of the cylindrical member 8 (FIG. 9). Upon mixing the first component and the second component, a user may remove the stopper ring 6 and the resin band D and may next fasten the seal cap 5. As a result, the cylindrical member 8 affixed at the step portion of the spray nozzle body 7b moves down (FIG. 10) to expose the circumferential recess 10 to the inner space of the bottle 2 from the bottom end of the lower part 9a of the sealing member 9 and thereby permit the first component to flow out of the circumferential recess 10 into the bottle 2. Reference numeral 17 denotes an air hole, 18 denotes a sealing member on the part of the seal cap 5.

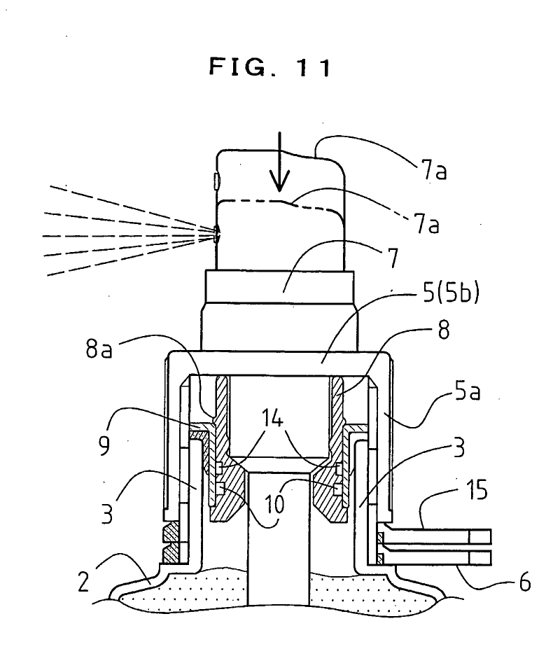

FIG. 11 shows a modification having first and second circumferential recesses 10 and 14 vertically spaced from each other in the outer surface of the cylinder 8, and having first and second stopper rings 6, 15 at the bottom end of the seal cap 5 as better understood with reference to FIG. 5 for comparison purposes. In this example, a user may remove the first stopper ring 6 alone to permit the first component to flow out of the first circumferential recess 10 into the bottle 2 for use over a certain initial period. If the sterile water in the bottle 2 is reduced in sterilizing power in a long time after the first use, the user may remove the second stopper ring 15 to permit the additional quantity of the first component held in the second circumferential recess 14 to flow into the bottle 2, thereby restoring the initial level of sterilizing power.

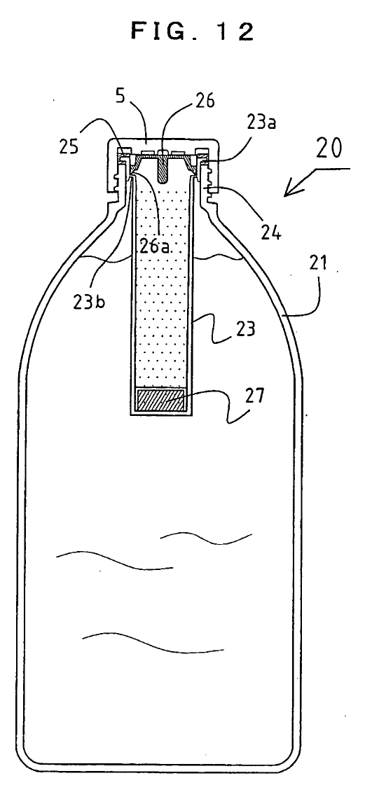

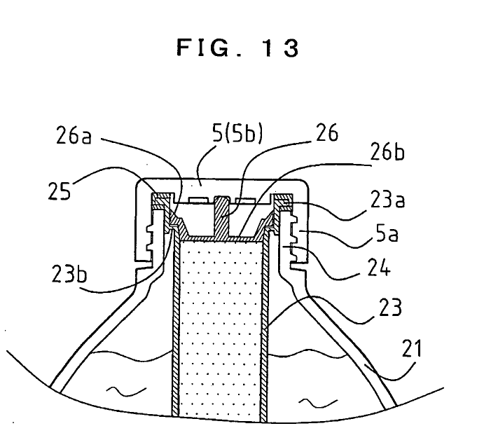

### SECOND EMBODIMENT (FIGS. 12 AND 13)

With reference to FIGS. 12 and 13, a package of sterile source materials 20 according to the second embodiment has a self-standing bottle 21. The bottle 21 may be a portable tank for one liter or for 10 liters or more, for example. It is effective from the viewpoint of the manufacturing cost to manufacture the bottle 21 as a molded product of a chemical-resistant plastic material.

The bottle 21 houses an inner container 23 in a sealed condition. The internal volume of the inner container 23 may be relatively small if it is intended to contain the first component in powder. The inner container 23 is typically made of a chemical-resistant plastic material or film material. That is, the inner container 23 may be either a bottle or a bag.

The inner container 23 has an outer flange 23a along the upper edge thereof for engagement with the end surface of a bottle mouth 24 formed. The outer flange 23a engages with a sealing member 25 held between the upper end of the bottle 24 and seal cap 5. Thus, the inner container 23 forms an independent sealed space inside the bottle 22.

A cutting-aid element 26 having a blade 26a is detachably affixed to the inner surface of the top plate 5b of the seal cap 5. When the bottle 21 is shipped for commerce toward users, the cutting-aid element 26 is affixed to the seal cap 5 to face its blade 26a directed upward. In this state, the cutting-aid element 26 functions to close the opening of the inner container 23 with a body 26b thereof (FIG. 13). The bottle 21 holds one of the first and second components, and the inner container 23 contains the other component.

A user having obtained the package of sterile source materials 20 according to the second embodiment may remove the seal cap 5 and may reverse the cutting-aid element 26 to face the blade 26a downward (FIG. 12). After that, the user may bring the seal cap 5 into screw engagement with the bottle mouth 24. As a result, the cutting-aid element 26 is pressed down by the top plate 5b of the seal cap 5, and the blade 26a bites into the horizontal step portion 23b of the inner container 23 and cuts it. Thus, the inner container 23 falls into the bottle 21, and the component in the inner container 23 flows out into the bottle 21. To aid the falling of the inner container 23, a weight 27 is preferably added to the bottom of the inner container 23, for example. The user is recommended to shake the bottle 21 up and down, and right and left, to promote the mixture of the components in the bottle 21. Instead of cutting the horizontal step portion 23b with the blade 26a of the cutting-aid element 26, a weakened line may be formed in the horizontal step portion 23b such that the horizontal step portion 23b is cut along the weakened line when the cutting-aid element 26 is pressed down.

The package of sterile source materials 20 as the second embodiment is convenient for supply of a relative large volume of source materials to users. The first and second components may be conditioned to assure that the sterile water prepared by mixing the components in the bottle 21 in the aforementioned procedures has an effective chlorine concentration of 10,000 ppm, for example. After preparing the sterile water in the bottle 21 sealed by the seal cap 5, the user can divide it to small parts and may appropriately dilute each part with water for actual use. This mode of use will be convenient for use in hospitals or other sites that consume a large amount of sterile water.

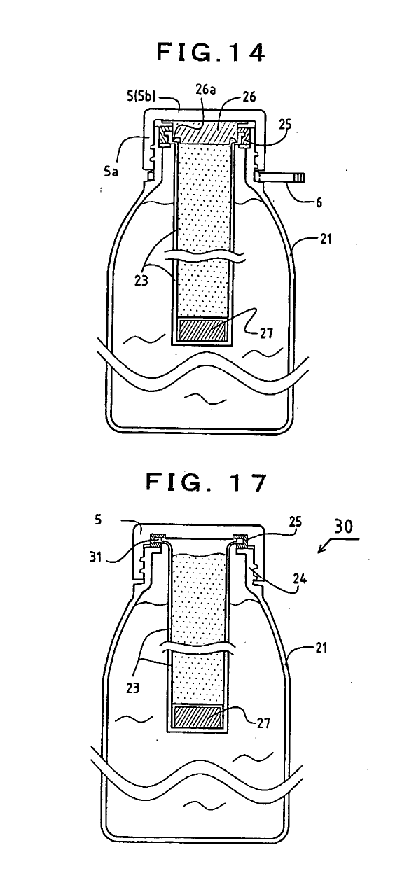

### MODIFICATIONS OF THE SECOND EMBODIMENT (FIGS. 14 THROUGH 16)

With the package of sterile source materials 20 according to the second embodiment explained above, users must once remove the seal cap 5 and set the cutting-aid element 26 upside down upon preparing the sterile water. However, the cutting-aid element 26 may be fixed to the top plate 5b of the seal cap 5 and the stopper ring 6 may be formed integrally on the skirt portion 5a of the seal cap 5 as shown in FIG. 14. Then, a user can make the inner container 23 drop in the bottle 21 by removing the stopper ring 6 and fastening the seal cap 5 to drive the cutting-aid element 26 downward. Instead of the blade 26a of the cutting-aid element 26, an element such as a rod extending downward may be provided in combination with a plug closing the bottom of the inner container 23. In this case, when the seal cap 5 depresses the cutting-aid element 26 downward, the rod extending downward from the cutting-aid element 26 pushes down a plug serving substantially as the bottom of the inner container 23 and thereby opens the inner container 23.

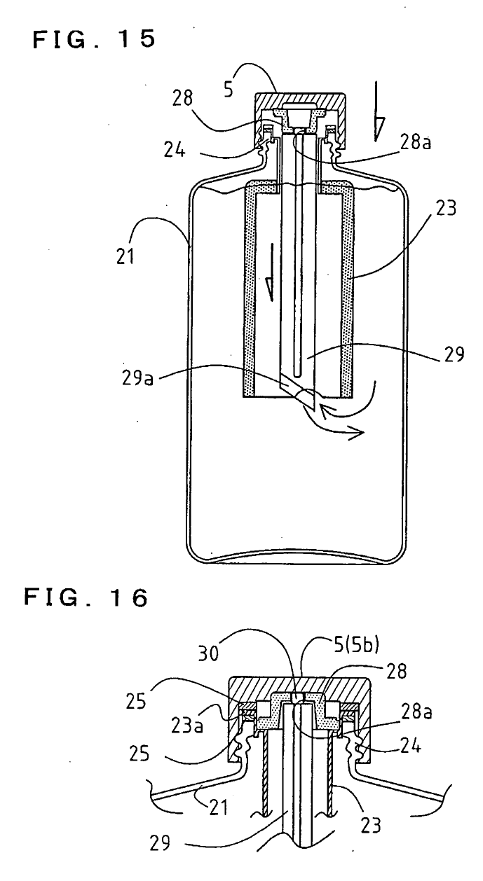

As another modification of the package of sterile source materials 20 according to the second embodiment explained above, a hat-shaped retainer 28 may be provided inside the seal cap 5 to drive an elongated cutter 29 by reversing the hat-shaped retainer 28 as shown in FIGS. 15 and 16. More particularly, the elongated cutter 29 has formed at the upper end thereof a projection 30 that is removably engageable in a hole 28a in the hat-shaped retainer 28. The cutter 29 is fixed to the retainer 28 by bringing the projection 30 thereof into close by removable engagement with the hole 28a. For preparing the sterile water, a user may remove the seal cap 5 and may next remove, from the seal cap 5, the hat-shaped retainer 28 in close fitting in a concavity in the top plate 5b of the seal cap 5 as shown in FIG. 16. Subsequently, the user detaches the cutter 29 from the hat-shaped retainer 28, then turns the hat-shaped retainer 28 upside down, next attaches the cutter 29 again to the retainer 28, and inserts the cutter 29 into the inner container 23. After that, once the user puts the seal cap 5 onto the bottle mouth 24 again by screw engagement (FIG. 15), the cutter 29 is pushed down by the hat-shaped retainer 28, and a blade 29a at the distal end of the cutter 29 bites into and cuts the bottom of the inner container 23. Thus, the component in the inner container 23 will flow out into the bottle 21. The “cutting” herein contemplates making a hole in the bottom of the inner container 23 as well. In the modification shown in FIGS. 15 and 16, a bag of a sheet material is preferably employed as the inner container 23. In this case, a lengthwise rib is preferably formed on the cutter 29 to prevent the bag-shaped inner container 23 from clinging to the cutter 29 and being damaged thereby.

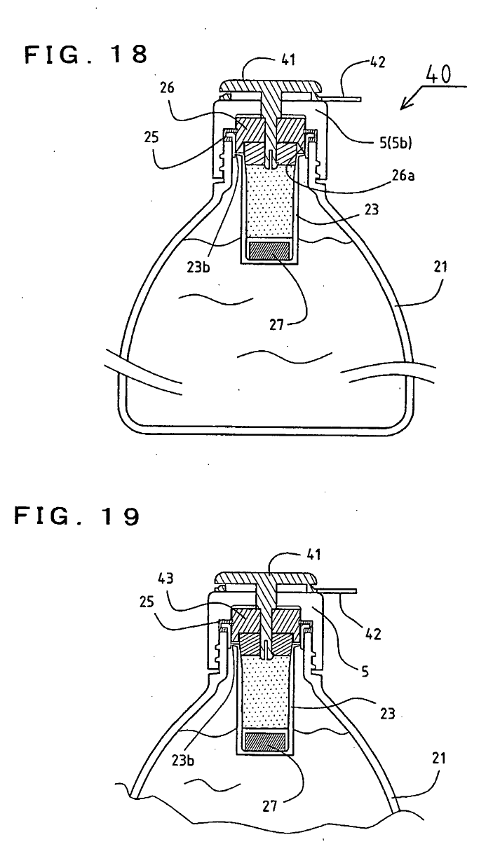

### THIRD EMBODIMENT (FIG. 17)

FIG. 17 shows a package of sterile source materials 30 according to the third embodiment. In this embodiment, an outer flange 31, for example, is provided along the top open end of the inner container 23. The package 30 is supplied to users with the outer flange 31 being held between the seal cap 5 and the top end face of the bottle 21 via a sealing member 25.

A user having obtained the package of sterile source materials 30 according to the third embodiment may remove the seal cap 5, next push the outer flange 31 of the inner container 23 into the bottle 21 with a finger, and then put the seal cap 5 onto the bottle 21 again. Thereafter, the user may shake the bottle 21 well to make the inner container 23 drop and thereby make the component in the inner container 23 mix into the bottle 21. For this purpose, at least the upper portion of the inner container 23 is preferably made of a flexibly deformable soft material.

### FOURTH EMBODIMENT (FIG. 18)

A package of sterile source materials 40 according to the fourth embodiment includes a pusher 41 that is accessible from outside such that a user may press the pusher 41 to cut the inner container 23 and thereby causes the component in the inner container 23 to flow out into a bottle 21. A lever 41 may be added to the pusher 41 such that depression of the lever causes downward movement of the pusher 41 according to the principle of leverage.

In the illustrated package of sterile source materials 40, the top plate 5b of the seal cap 5 has the pusher 41 extending through it. The pusher 41 has a stopper ring 42 formed as an integral part thereof. The pusher 41 has a cutting aid 26 fixed thereto. When a user presses the pusher 41 strong after removing the stopper ring 42, the cutting-aid element 26 moves down, and a blade 26a of the cutting-aid element 26 bites into and cuts off a horizontal step 23b of the inner container 23. As a result, the inner container 23 drops into the bottle 21, and the component therein flows out into the bottle 21. Instead of the blade 26a of the cutting-aid element 26, an element such as a rod extending downward may be provided in combination with a plug closing the bottom of the inner container 23. In this case, when the seal cap 5 depresses the cutting-aid element 26 downward, the rod extending downward from the cutting-aid element 26 pushes down the plug serving as the bottom of the inner container 23 and thereby opens the inner container 23.

### MODIFICATIONS OF THE FOURTH EMBODIMENT (FIG. 19)

The package of sterile source materials 40 shown in FIG. 18 is configured to drive the component in the inner container 23 to flow into the bottle 21 by depressing the cutting-aid element 26 and thereby cutting the inner container 23. However, the package of sterile source materials 40 may be modified as shown in FIG. 19 as a modification to fix a push-down member 43 to the pusher 41 such that a downward pressing force can be applied to the horizontal step 23b of the inner container 23 via the push-down member 43 by depressing the pusher 41 strong downward to force the inner container 23 to drop. For this purpose, at least the upper portion of the inner container 23 is preferably made of a flexibly deformable soft material.

As another modification, the inner container 23 may be omitted from the package of FIG. 19, and instead, a circumferential recess such as the circumferential recess 10 shown in FIG. 4, etc. may be formed in the outer circumferential surface of the push-down member 43 to contain the first or the second component in the circumferential recess 10.

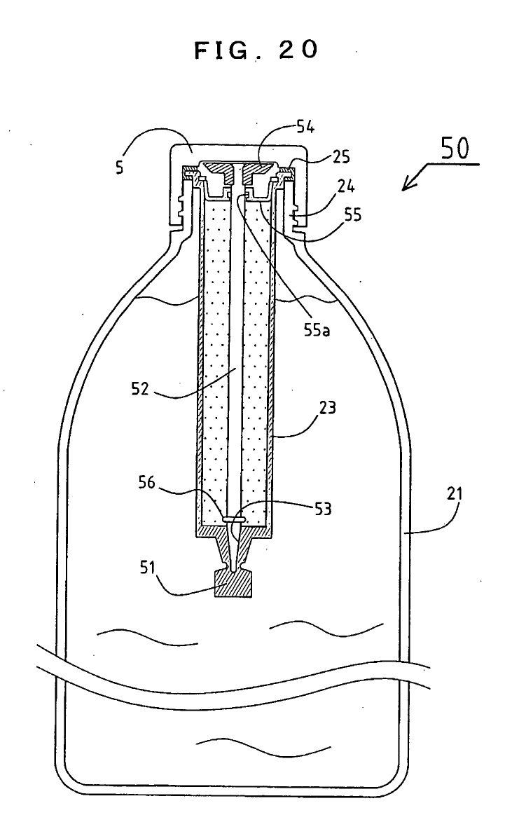

### FIFTH EMBODIMENT (FIG. 20)

The package of sterile source materials 50 shown in FIG. 20 includes a tab 51 formed integrally at the lower end of the inner container 23, although not indispensable, such that a communication hole 53 can be made at the bottom of an inner container 23 when the tab 51 is snapped off. The distal end of a shaft 52 extending vertically in the inner container 23 extends into the communication hole 53 to close the communication hole 53. That is, the distal end of the shaft 52 functions as a movable valve body. Furthermore, an operation flange 54 is fixed to the top end of the shaft 52. The inner container 23 is closed by a piston 55 in close fitting in the inner container 23 after the first or second component is introduced into the inner container 23. The shaft 52 penetrates through the piston 55.

With the package of sterile source materials 50, a user may remove the seal cap 5, next take out the inner container 23 from the bottle mouth 24 and pull up the operation flange 54 to lift the shaft 52. The shaft 52 has a flange 56 at the lower end thereof. When the shaft 52 is lifted, the flange 56 is brought into engagement with a circumferential recess 55a formed on the piston 55, and the shaft 52 and the piston 55 join in form of a one-piece structure. Thereafter, the user may snap off the tab 51 from the lower end of the inner container 23.

Subsequently, the user can inject the first or second component heretofore held in the inner container 23 into the bottle 21 by depressing the operation flange 54 to drive the piston 55 downward. The manipulation for injection may be conducted either with the inner container 23 being set on the bottle mouth 24 or with the distal end of the inner container 23 oriented toward the bottle mouth 24.

After completion of the injection, the user is recommended to shake the bottle 21 well to mix the components in the bottle 21 while maintaining the bottle 21 in a sealed condition with the seal cap 5. When using the prepared sterile water, the user can make use of the inner container 23 equipped with the piston 55 as a syringe. More specifically, the user may pull up the manipulation flange 54 to lift the piston 55 and may draw up a suitable amount of the sterile water into the inner container 23. After that, when the user takes out the inner container 23 from the bottle 21 and depresses the operation flange 54 while facing the inner container 23 toward an affected part of the body to be sterilized, the user can spout the sterile water from the inner container 23 toward the affected part.

As a modification of the package of sterile source materials 50, the inner container 23 may have a fully closed bottom such that a user removes the seal cap 5, then takes out the inner container 23 and pours the component in the inner container 23 into the bottle 21. This modification will be convenient in case the inner container 23 contains powder as the first component.

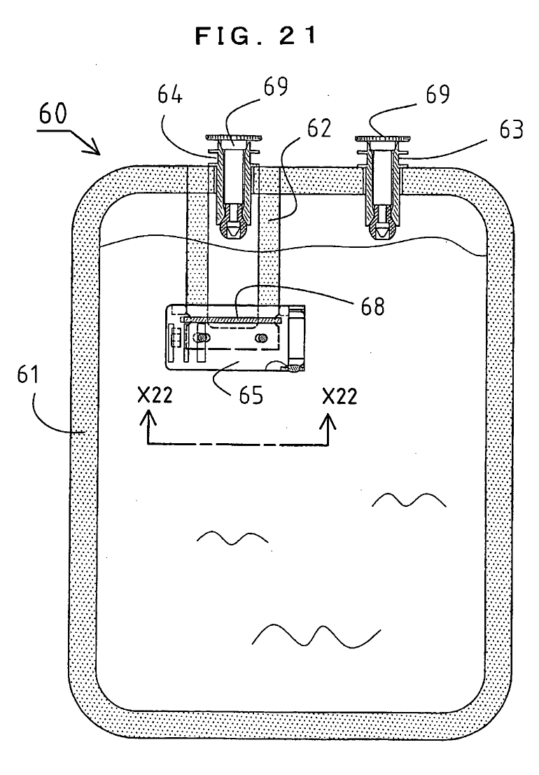

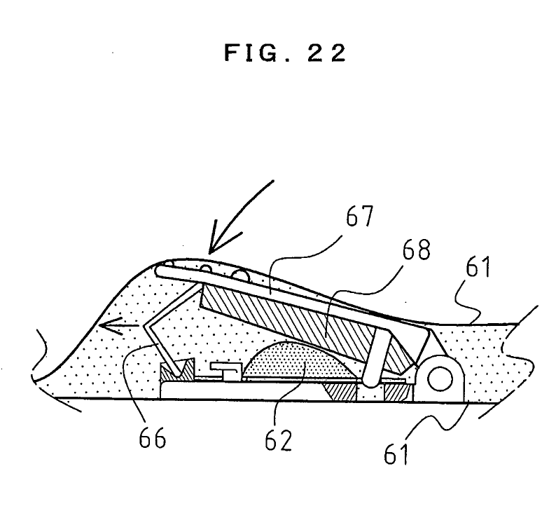

### SIXTH EMBODIMENT (FIGS. 21 AND 22)

FIGS. 21 and 22 show a package of sterile source materials 60 as the sixth embodiment, which is convenient in case the two containers, inner and outer, are made of a soft chemical-resistant sheet material. In the illustrated package of sterile source materials 60, both the outer container 61 and the inner container 62 are flat bags made of a chemical-resistant sheet material. Bags of this type are widely used as packages for retort pouches of boil-in-bag foods, so their detailed explanation is omitted herein.

The inner bag 62 has a part thereof welded to the marginal portion of the outer bag 61. The package of sterile source materials 60 has a first mouth member 63 communicating with the inner space of the outer bag 61, and a second mouth member 64 communicating with the inner space of the inner bag 62. The first and second mouth members 63 and 64 are thermally welded to edges of the outer and inner bags 61 and 62, respectively, in a liquid-tight condition.

The outer bag 61 contains a cutting-aid element 65 to cut through the inner bag 62. The cutting-aid element 65 includes a lever 67 biased by a spring 66. When the lever 67 is pressed down, a blade 68 provided on the lever 67 cuts the inner bad 62.

The package of sterile source materials 60 is prepared by first removing stop pins 69 from the first and second mouth members 63 and 64 respectively, then charging the outer bag 61 with one of the first and second components and the inner bag 62 with the other component through the first and second mouth elements 63, 64 respectively, and thereafter inserting the stop pins 69 again into the first and second moth elements 63, 64 to close the them. In this status, the package of sterile source materials 60 is supplied to consumers.

For using the package of sterile source materials 60, a user may put the container 60 on a floor or ground and step on the cutting-aid element 65 from above the outer bag 61 with a foot of the user. As a result, at least a part of the inner bag 62 will be cut through, and the component in the inner bag 62 will flow out into the outer bag 61. Thus, the first and second components will be mixed together in the outer bag 61 to produce the intended sterile water. The sterile water in the package 60 can be discharged by removing the stop pin 69 from the first mouth 63 of the outer bag 61.

To prevent the outer bag 61 from being damaged by the lever 67 or the like when the user steps on the package 60, the spring 66 is preferably a bent pin so that the bent pin (66) bends outwardly and urges the adjacent part of the outer bag 61 away from the mechanism including the lever 67 when the user steps on the lever 67 through the outer bag 61.

### SEVENTH EMBODIMENT (FIGS. 23 AND 24)

The package of sterile source materials 70 according to the seventh embodiment makes use of the inner space of the mouth 63 of the outer bag 61 as a second sealed container space. The mouth 63 is shaped cylindrical, and houses an inner container 71 that is a cylindrical member having a bottom. The inner container 71 contains a cutter 72 whose blade 72a is oriented downward.

When using the package of sterile source materials 70, a user may remove a stopper ring 6 from a seal cap 5, and may next tighten the seal cap 5. As a result, the cutter 72 is depressed by the seal cap 5 to move down and cut the bottom of the inner container 71. Thus, the first or second component in the inner container 71 is allowed to flow out into the outer bag 61. To facilitate the flow of the component into the outer bag 61, a through-hole 73 is preferably formed in the cutter 72.

As a modification of the package of sterile source materials 70 according to the seventh embodiment, the soft outer bag 61 may be replaced by a non-self-standing, light-weight plastic container.

The package of sterile source materials 70 using either the soft outer bag 61 or the light-weight plastic container is preferably packed, normally together with other such packages, in a cardboard box when supplied to consumers.

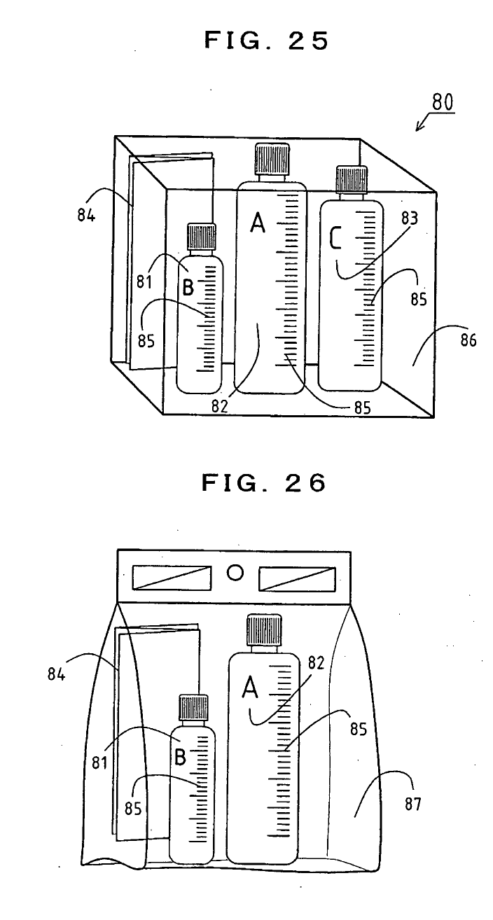

### EIGHTH EMBODIMENT (FIG. 25)

FIG. 25 shows a sterile water preparation kit according to the eighth embodiment of the invention. The sterile water preparation kit 80 includes a first bottle 81 packaging the first component, a second bottle 82 packaging the second component, and a third bottle 83 packaging water. The kit 80 preferably includes, in combination, an instruction manual 84 describing instructions concerning the mixing operation of the components by the user. The first to third bottles 81 to 83 preferably have scale marks 85. At least the first and second bottles 81, 82 are preferably made of a plastic material resistant to chemicals and capable of blocking light.

The manual 84 may include a list of relations among volumes of water, volumes of the first component, volumes of the second components, volumes and concentrations of sterile water produced by mixing such volumes of water, first component and second component. Users may refer to the list, and can prepare a desired volume of sterile water by first pouring an instructed a quantity of water into the third bottle 83, and next introducing instructed quantities of the first and second components from the first bottle 81 and the second bottle 82, respectively, into the third bottle, following the instructions in the manual.

The third bottle may be supplied to users with no water therein. In this case, referring to the instruction manual 84, the user of the sterile water preparation kit 80 may first charge the third bottle 83 with a specified quantity of water, and may next pour the first and second components from the first and second bottles 81 and 82, respectively, into the third bottle 83 to prepare the sterile water.

It will be convenient to pack one or more sterile water preparation kits 80 in a corrugated cardboard box 86, for example, when supplied to consumers. This will be convenient also for users who will prefer to purchase one or more boxes of such kits 80 at once and stock them in store rooms, for example.

The third bottle 83 may contain a pH control liquid. For example, the third bottle 83 may contain a pH control liquid such as diluted hydrochloric acid (HCl) or diluted NaOH such that a user can use the pH control liquid in the third bottle 83 for fine adjustment of pH of the sterile water when preparing the sterile water with the sterile water preparation kit 80 stored for a long time under an unfavorable environment.

### MODIFICATIONS OF THE EIGHTH EMBODIMENT (FIGS. 26 TO 28)

For supply to users, the sterile water preparation kit 80 may be a set of the first and second bottles 81 and 82 containing the first and second components, respectively, and the instruction manual 84, which are held together in a water-proof bag 87 as shown in FIG. 26. With this kit 80, a user can prepare a sterile water of a predetermined concentration and a pH level in the slightly acidic or neutral region by first introducing a specified amount of water into a suitable container and next introducing the components from the first and second containers 81 and 82 in accordance with the instructions in the manual 84.

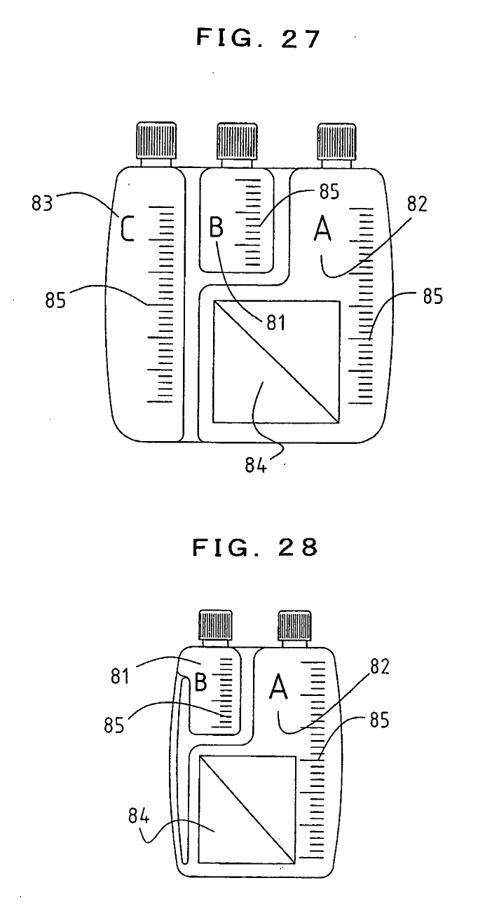

The sterile water preparation kit 80 may use a single container having three separate interior spaces that serve as the first to third bottles 81 to 83 as shown in FIG. 27. In this case, the manual 84 may be bonded on one outer surface of the container. Alternatively, a pocket may be formed on one outer surface of the three-partitioned single container to supply the kit 80 with the manual 84 held in the pocket to consumers. Alternatively, the sterile water preparation kit 80 may use a single container having two separate interior spaces that serve as the first and second bottles 81, 82 as shown in FIG. 28. Here gain, the manual 84 may be attached to the two-partitioned single container.

A fourth bottle containing an alkali control liquid (pH control liquid) such as sodium hydroxide to the sterile water preparation kit 80 and its modifications shown in FIGS. 25 through 28. In this case, a means for examining the pH level, such as litmus paper, may be added. In case a user must use a sterile water preparation kit 80 stored for a long time or under an unfavorable environment, and can estimate that the sterile water will be biased toward the acidic side than pH 5, for example, even when prepared pursuant to the instructions in the manual 84, it is desirable that a user can adjust the pH level of the sterile water to approximately 5.5 by pouring the alkali control liquid from the fourth bottle while monitoring the pH level with the pH examination means.

It should be noted that the present invention can be embodied by appropriately combining the various elements employed in the foregoing embodiments. For example, outer containers, 2, 21, 61, inner container 23 and/or first to third bottles 81-83 may be replaced by non-self-standing, thin-film plastic containers.

In the various embodiments explained above, since the prepared sterile water will have a pH level within the neutral or slightly acidic region, it is possible to prevent generation of any toxic gas such as gaseous chlorine in the process of mixing the first and second components. In addition, since the first and second components are mixed in the air-tight container closed by the seal cap 5, users are free from the risk of touching the chemicals (first and second components), and can prepare the sterile water safely.

According to some recent reports, the hypochlorous or chlorous acid of pH 5.5 and the effective chlorine concentration of 50 ppm, for example, can effectively kill yeast, staphylococcus aureus, CNS, bacillus, micrococcus, acinetobacter, MRSA, etc. Therefore, the embodiments of the invention, which enable sterilization with hypochlorous or chlorous acid whenever and wherever necessary, can immediately cope with social issues such as in-hospital infection without the need of special equipment.

Sterilization with hypochlorous or chlorous acid of a pH level in the slightly acidic or neutral region has not so far been usable in general households. However, the invention can provide inexpensive products according to any of the embodiments to the consuming public. Therefore, the consuming public can readily acquire those products and can easily use them for sterilization with hypochlorous or chlorous acid in general households. Moreover, the consuming public can always stock such products for self-defensive purposes against sudden prevalence of a disease such as SARS in each household. As already explained, sterilization by hypochlorous acid is common to the sterilization mechanism by neutrophilic leucocytes in living bodies. Therefore, hypochlorous acid is harmless to living bodies even when it is taken into bodies through aspiration or food. Thus, the sterile water can be sprayed in human life spaces for sterilization thereof by way of home-use humidifiers (preferably supersonic humidifiers). In this case, since the sterile water performs a deodorant effect, it is simultaneously useful for deodorization of the life spaces. In addition, the sterile water is usable for cleaning and sterilizing foods, dishes and other eating utensils.

For use in military forces, any appropriate products according to the embodiments of the invention may be stocked in individual camps to cope with terrorist attacks using biological weapons or emergency medical activities.

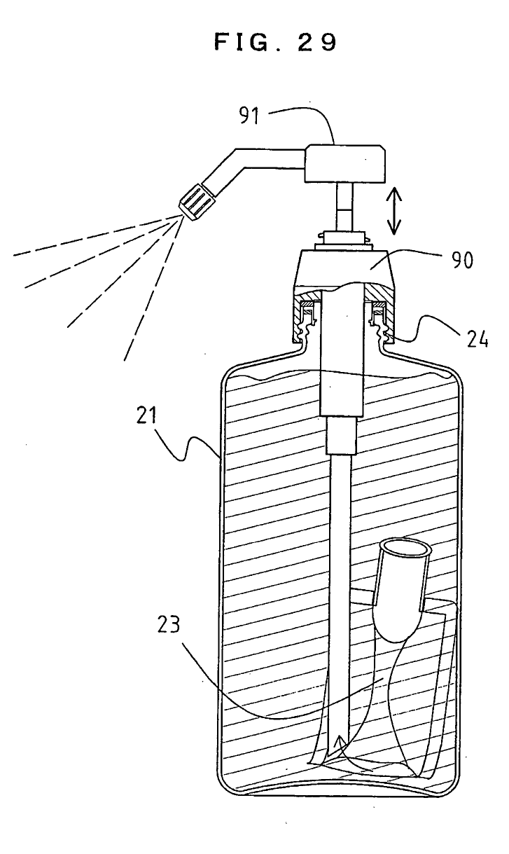

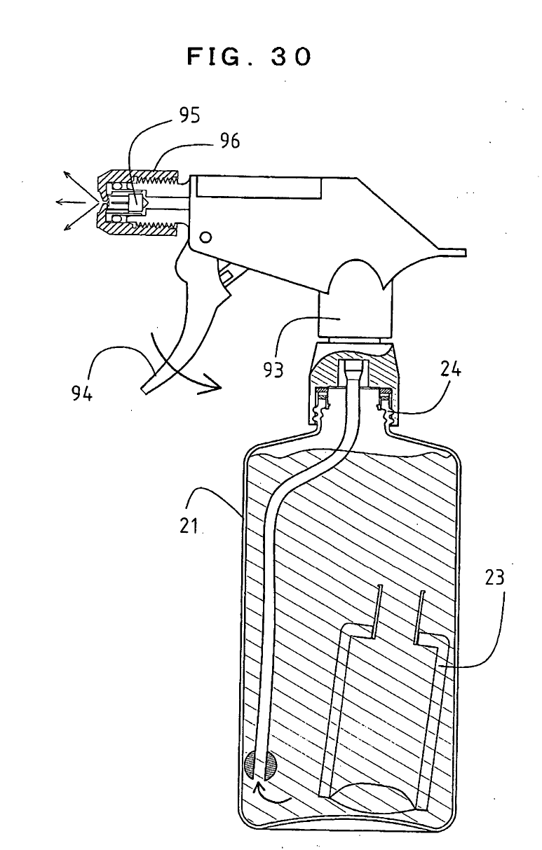

In sterilization using any product according to the embodiments of the invention, a sprayer 90 shown in FIG. 29 may be attached to the mouth 24 of the bottle 21 used to mix the components to make the sterile water, and the sterile water can be spouted by operating the sprayer 90. The sprayer 90 can spray the sterile water from the bottle 21 when a head 91 thereof is depressed. The sterile water can be discharged also by another type of sprayer 93 as shown in FIG. 30. The sprayer 93 shown in FIG. 30 can spray the sterile water from the bottle 21 when a trigger lever 94 thereof is pulled. FIGS. 29 and 30 show the bottle 21 used in the embodiment already explained with reference to FIG. 15.

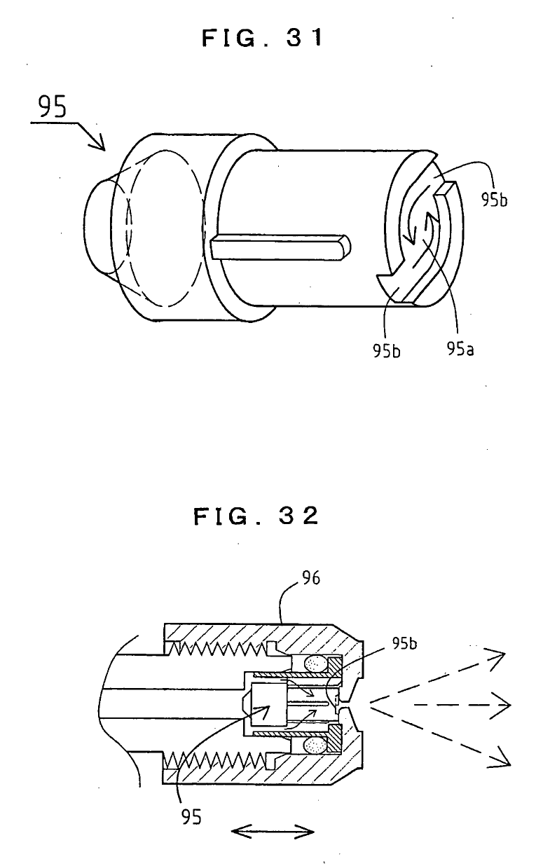

The sprayers 90, 93 shown in FIGS. 29 and 30 preferably has a confluence promoter 95 as shown in FIG. 31 in their spray outlets and preferably includes a cap 96 as shown in FIG. 32, which can control the atomized condition of the sterile water.

More specifically, the confluence promoter 95 has a swirl-and-confluence portion 95a at its distal end. Sterile water drawn up from the bottle 21 enters into the swirl-and-confluence portion 95a through two opposed cutouts 95b, 95b in the distal end surface of the mixture promoting member 95, and it is stirred there and discharged externally. The discharged sterile water can be changed from a linear jet stream to an atomized form by adjustment of the tightening of the cap 96.

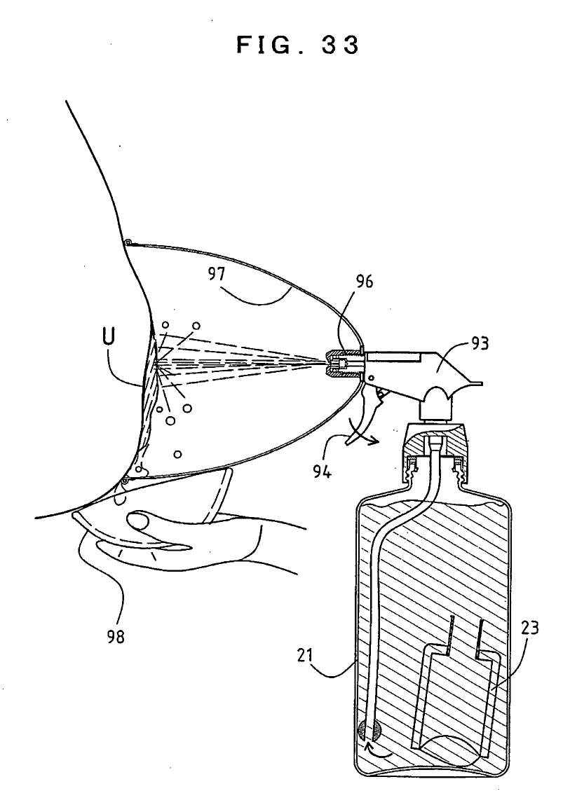

The sprayer 93 shown in FIG. 30 may be used in combination with an embracing cover 97 as shown in FIG. 33 for medical treatment. Upon a medical treatment, the sterile water may be discharged in form a linear jet flow by adjusting the tightening of the cap 96 depending upon a the condition of a wound U to sterilize it or to squeeze pus from the wound. The sterile water used for the treatment may be collected in a tray 98 to keep the environmental sanitation.

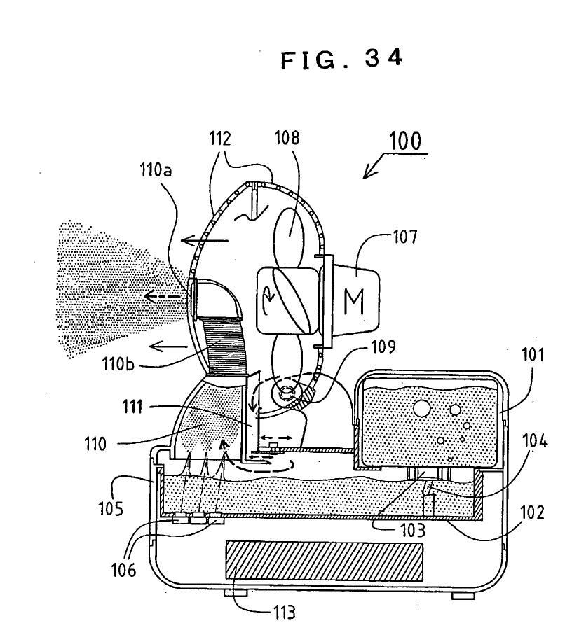

For spatial sterilization in a hospital, for example, it is desirable that the sterile water can be sprayed without noise. FIG. 34 shows a portable indoor spatial sterilization apparatus 100 suitable for this purpose. The spatial sterilization apparatus 100 includes a tray 102 for receiving sterile water containing hypochlorite supplied from a cartridge tank 101. A cap 103 of the cartridge tank 101 has a movable pin 104. The outlet of the cap 103 opens in response to a movement of the movable pin 104. When the water level in the tray 102 lowers below the lower surface of the cap 103, air enters into the cartridge tank 101 through the cap 103, a quantity of sterile water is allowed to drop into the tray 102. Thus, the tray 102 keeps a constant water level. The tray 102 is held in the apparatus body 105 of the apparatus 100, and the sterile water in the tray 102 is atomized to fine particles by an ultrasonic generator 106.

The spatial sterilization apparatus 100 further includes a main fan 108 located in an open space and driven by an electric motor 107. The main fan 108 and the motor 107 are disposed above the apparatus body 105 and can be adjusted in vertical orientation about an axis 109.

The sterile water atomized by the ultrasonic generator 106 is introduced to near and in front of the main fan 108 through a first passage 110 extending upward from the apparatus body 105. To promote this flow of the sterile water, part of an air flow generated by rotation of the main fan 108 is supplied into the apparatus body 105 through a second passage 110. With the aid of the air flow supplied from the second passage 110 into the apparatus body 105, fog of the sterile water atomized by the supersonic generator 106 is transported to the proximity of the main fan 108.

An outlet 110a of the first passage 111 is preferably open toward the front of the unit 100. The outlet 110a is preferably disposed adjacent to and in front of the center of the main fan 108. The outlet 110a can be adjusted in position by means of bellows 110b forming a part of the first passage 110. The main fan 108 is preferably enclosed by a net 112, for example, for safety purposes.

The motor 107 and the ultrasonic generator 106 are controlled by a powering/controlling portion 113 housed in the body 105.

According to the spatial sterilization apparatus 100, it is possible to spread sterile water over a wide area without noise by means of the main fan 108 located in an open space. Therefore, it is usable for spatial sterilization of patient rooms heretofore unacceptable because of air-blasting noise. When patient rooms are sterilized by the spatial sterilization apparatus 100, patients are not afflicted with air-blasting noise. Further, since the sterile water is harmless, spatial sterilization of patient rooms of physically weak patients is made possible. Simultaneously, the issue of unfavorable odor of patient rooms can be eliminated by the excellent deodorant effect of the sterile water. Sterile water to be refilled in the cartridge tank 101 can be easily prepared near the apparatus 100 by using a package of sterile source materials or a sterile water preparation kit according to the invention. In this case, the sterile water containing hypochloric acid prepared by using the package of sterile source materials or the sterile water preparation kit may be directly refilled in the cartridge tank 101 and used for spatial sterilization. Preferably, the sterile water containing hypochloric acid prepared by using the package of sterile source materials or the sterile water preparation kit is diluted adequately before being refilled in the cartridge tank 101. When the sterile water preparation kit is used, the user may prepare sterile water of an optimum concentration for spatial sterilization with reference to the scale 85, and may spray it in a room with the spatial sterilization apparatus 100. It is also acceptable to use the bottle 21, already explained, in lieu of the cartridge tank 101.

The main fan 108 of the spatial sterilization apparatus 100 may be a cross-flow fan. As already known, the cross-flow fan is configured to discharge an average flow uniform in density in a direction perpendicular to the gas-sucking direction, and it is characterized in small air-blasting noise. A second electrically driven fan of a relatively small size may be provided in the apparatus body 105. In this case, an air flow generated by the second electric fan carries fog of atomized sterile water to the proximity of the main fan 108, and an air flow generated by the main fan 108 carries fog of the atomized sterile water to a distance.

To prevent an excessive rise of the room temperature, the spatial sterilization apparatus 100 may include an automatic control mechanism to automatically execute intermittent spray of sterile water, for example, by spraying sterile water for three minutes and interrupting the spray for the next 10 minutes. The spray control mechanism may be combined with a sensor for detecting the humidity and temperature of rooms, for example, to automatically control the duration of the spray and the duration of the interruption in accordance with the detected humidity and temperature of the room. Alternatively, a programmed control pattern may be incorporated in the control mechanism to enable variable control of the duration of the spray and the duration of the interruption according to the control pattern.

Sterile water containing hypochloric acid to be charged in the cartridge tank 101 of the spatial sterilization apparatus 100 has an effective chlorine concentration in the range 50 to 200 ppm, although it is not limitative.

The spatial sterilization apparatus 100 has been explained above as being portable. However, it may be a stationary apparatus supplied with sterile water through a pipe arrangement, for example. In this case, the apparatus is preferably designed to accept the supply of sterile water to the ultrasonic generator 106 selectively from the pipe arrangement and the cartridge tank 101.

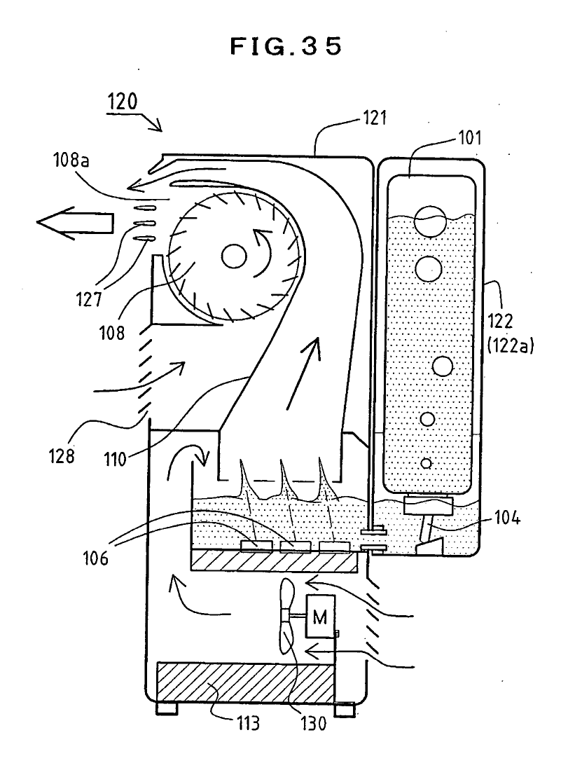

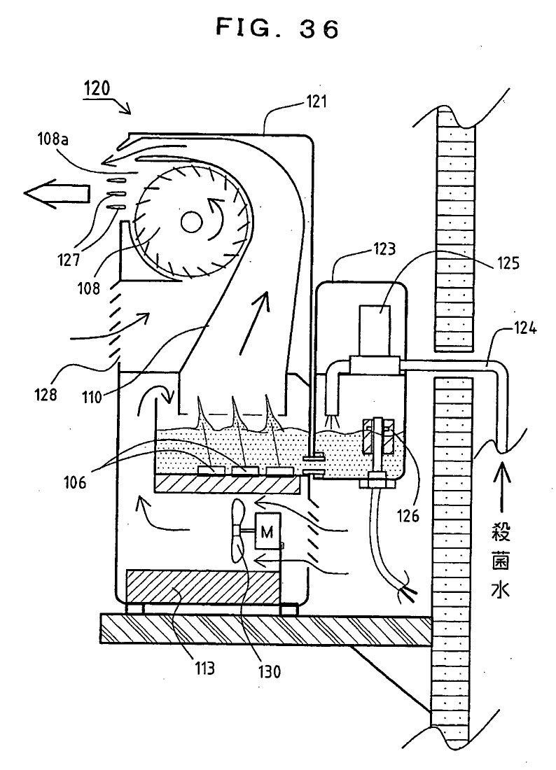

FIGS. 35 and 36 show a spatial sterilization apparatus 120 that can select any of the supply of sterile water from a cartridge tank (FIG. 35) and that from a pipe arrangement (FIG. 36) when a corresponding attachment is mounted. An outer case 121 of the apparatus 120 can selectively receive a first attachment 122 and a second attachment 123. When the first attachment 122 is mounted, the cartridge tank 101 can be taken out by removing a cover 122a. When the second attachment 123 is mounted, the apparatus 120 can be supplied with sterile water through the pipe arrangement 124 (FIG. 36). In FIG. 36, reference numeral 125 denotes an electromagnetic valve, and numeral 126 denotes a level sensor. The level sensor 126 and the electromagnetic valve 125 cooperate to keep a substantially constant level of the sterile water.

The spatial sterilization apparatus 120 shown in FIGS. 35 and 36 includes a cross-flow fan as its main fan 108. An air outlet 108a of the main fan 108 is provided with a louver 127. An air flow generated by the main fan 108 can be changed in orientation by changing the angle of the louver 127. The air outlet 108a of the main fan 108 faces to an open space, and no air duct is provided. The outer case 121 has an air inlet 128 preferably sized equal to or larger than the open area of the air outlet 108a.

The spatial sterilization apparatus 120 shown in FIGS. 35 and 36 includes a second electric fan 130. The second electric fan 130 carries fog of atomized water to the proximity of the main fan 108.

Heretofore, specific embodiments of the invention have been explained. However, the invention is not limited to these embodiments. For example, as shown in FIG. 37, a sleeve 140 having an upper end fixed to the top edge of the bottle mouth 24 may be provided to extend downward in the bottle 21, and upper and lower two plugs 142, 143 may be provided in close fitting with the sleeve 140 to define a sealed space between these two plugs 142, 143 in the sleeve 140. In this case, the sealed space is used as the inner container 23. To open the inner container 23, the upper and lower plugs 142, 143 may be connected by a vertical connector 144, and a rod 145 extending downward from the seal cap 5 may be provided to push the connector 144 downward. The rod 145 may be either a separate piece member from the seal cap 5 as shown in FIG. 37 or an integral part of the seal cap 5. When the stopper ring 6 is removed and the rod 145 is moved down by tightening the seal cap 5, the plugs 142 and 143 are pushed down. When the lower plug 143 gets out of the lower end of the sleeve 140, the component in the sleeve 140 flows out into the bottle 21.

The design using the detachable plug 142 for making the inner container as explained with reference to FIG. 37 is applicable to the inner container 71 shown in FIGS. 23 and 24, which is located at the mouth 63 of the outer bag 61. That is, as shown in FIG. 38, the plug 142 may be brought into engagement with the open lower end of the sleeve forming the sidewall of the inner container 71, and may be pressed down with the rod 145 associated with the seal cap 5 to open the inner container 71. In this case, the plug 142 preferably engages in liquid-tight fitting with the inner or outer lower-end circumferential surface of the sleeve forming the sidewall of the inner container 71.

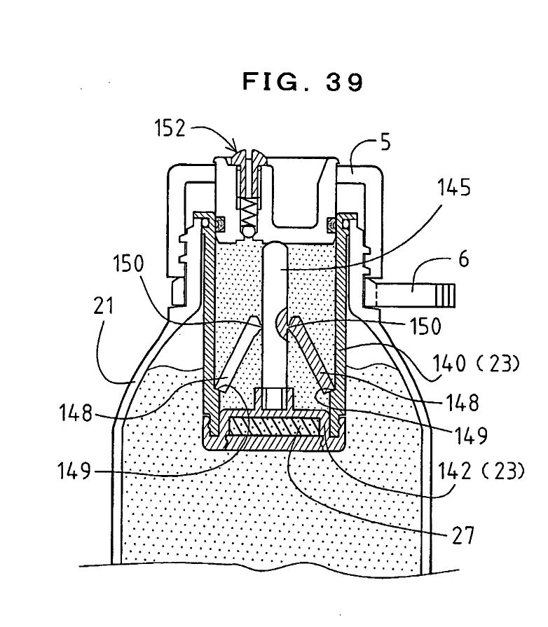

FIG. 39 shows an exemplary means for preventing unintentional dropping of the plug 142 from the inner container 23. In the example of FIG. 39, the rod 145 is fixed to the plug 142, and arms 148 formed as integral parts of the rod 145 are each supported with one end in engagement with a step portion 149 of the sleeve 140. Thus, the arms 142 function as stoppers for limiting downward movement of the rod 145, and therefore prevent unintentional downward movement of the rod 145 and accidental dropping of the plug 142. In order to facilitate intentional mixing manipulation, i.e. removal of the stopper ring 6 and tight closure of the seal cap 5 to drive the rod 145 downward, a weakened potion 150 is preferably formed in each arm 148 (for example, at the portion connected to the rod 145) such that the arms 148 break or bend at the weakened portions when the seal cap 5 is tightened.

FIG. 39 also shows the use of a relief valve 152 provided in the seal cap 5. As the internal pressure of the inner container 23 rises, the relief valve 152 opens to keep the pressure in the inner container 23 substantially constant. The relief valve 152 or other type pressure control means provided in association with the inner container 23 contributes to preventing a rise of the internal pressure in the inner container 23 as high as driving the plug 142 to move downward and drop from the sleeve 140.

The pressure release means shown in FIG. 39 is composed of a ball and a spring. Instead, however, a gas-liquid separation film may be used to selectively release gas generated in the inner container through the gas-liquid separation film. Alternatively, a soft packing pad having a cushioning effect (for example, a packing pad of a soft resin having discrete bubbles) may be used as a seal member of the seal cap 5 to allow gas to exit while prohibiting passage of liquid by adjusting the degree of compression.

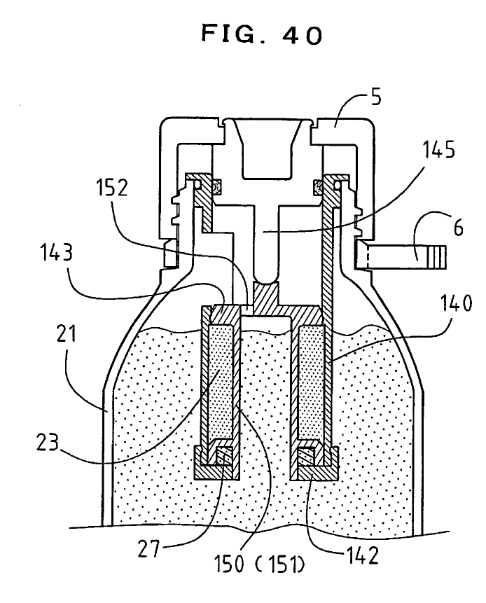

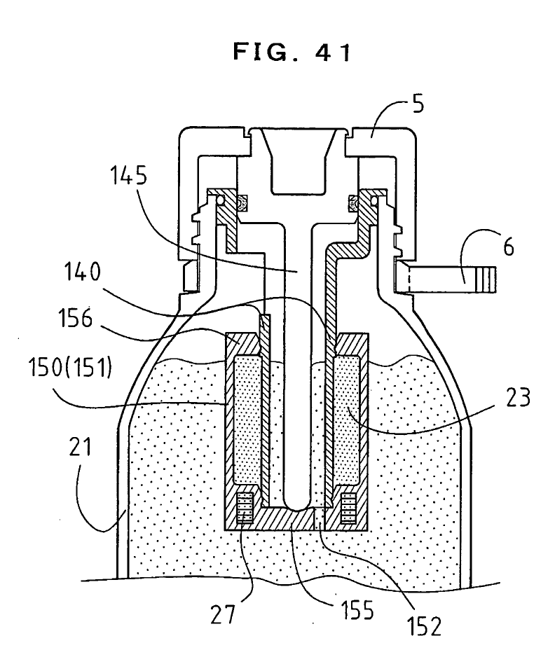

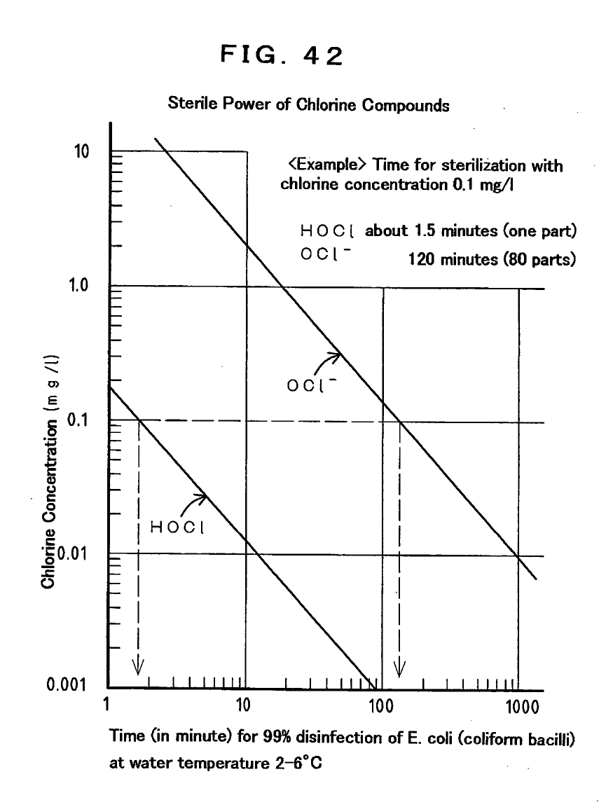

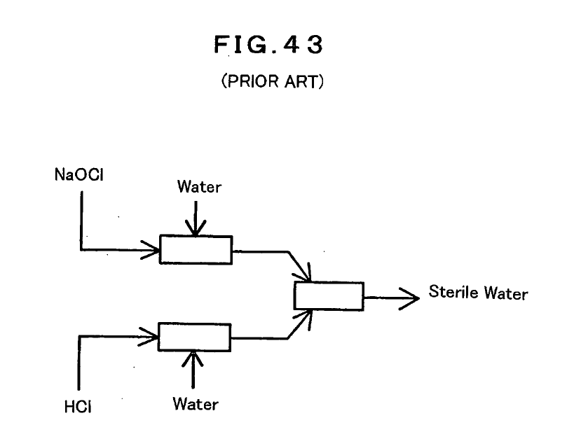

From another viewpoint, the modification show in FIG. 37 can be interpreted as composing the inner container 23 of two members (first member 140 and second members 144, 142, 143) movable relative to each other, opening the inner container 23 by moving the second member 144, 142, 143 while maintaining the first member 140 fixed to the outer container 21, and thereby permitting the component in the inner container 23 into the outer container 21. Further modifications based on this viewpoint are shown in FIGS. 40 and 41.

The modification of FIG. 40 includes a sleeve 41 (first member) fixed to the outer container, i.e. the bottle 21, and a second member 150 including two vertically distant flanges 142, 143. Thus, the second member 150 inserted in the sleeve 140 serves as the inner container 23.

Once the stopper ring 6 is removed and the seal cap 5 is fastened to drive the rod 145 downward, the rod 145 pushes the second member 150 downward. As a result, the inner container 23 is partly opened, and the component in the inner container 23 is permitted to flow our into the bottle 21. As shown in FIG. 40, if the body 152 of the second member 150 is cylindrical, a through hole is preferably formed as shown by reference numeral 152.

In the modification shown in FIG. 41, the second member 150 is located outside the sleeve 140; the lower end of the cylindrical body 151 of the second member 150 is closed by the bottom 155; and the bottom 155 is in liquid-tight engagement with the sleeve 140. The upper end of the cylindrical body 151 includes an inner flange 156, and the inner end of the inner flange 156 is in liquid-tight engagement with the sleeve 140. Thus, the inner container 23 is defined outside the sleeve 140.

Once the stopper ring 6 is removed and the seal cap 5 is fastened to drive the rod 145 downward, the rod 145 pushes the second member 150 downward. As a result, the bottom 155 of the second member 150 disengages and separates from the lower end of the sleeve 140, and the inner container 23 is partly opened and permits the component therein to flow out into the bottle 21.

What is claimed is:

1. A method of preparing a sterile water, comprising:
preparing a first component containing hypochlorite or chlorite and held in a first sealed space, and a second component containing an acid and held in a second sealed space; and
mixing the first and second components together to prepare a sterile water,
wherein the first and second components are conditioned so that the sterile water resulting from mixture of the first and second components has a predetermined effective chlorine concentration and a pH level within the slightly acidic or neutral region.

2. The method according to claim 1 wherein the first and second components are conditioned so that the sterile water resulting from mixture of the full quantity of the first component in the first sealed space and the full quantity of the second component in the second sealed space has a predetermined effective chlorine concentration and a pH level in the slightly acidic or neutral region.

3. The method according to claim 1 wherein the first sealed space is defined by a first container; and the second sealed space is defined by a second container.

4. The method according to claim 1 wherein the first and second sealed spaces are defined in a single container.

5. The method according to claim 1 wherein the first component is an alkali liquid having a pH level equal to or higher than 10.

6. A method of preparing a sterile water, comprising:
preparing a first component containing a hypochlorite or chlorite and held in a first sealed space, and a second component containing an acid and held in a second sealed space; and
mixing the first and second components with a predetermined amount of water to prepare a sterile water,
wherein the first and second components are conditioned so that the sterile water resulting from mixture of the first and second components with the predetermined amount of water has a predetermined effective chlorine concentration and a pH level within the slightly acidic or neutral region.

7. The method according to claim 6 further comprising:
preparing an instruction manual having a description on quantities of the water to be mixed,
wherein the instruction manual will guide a user to introduce the first and second components into the predetermined amount of water specified in the instruction manual.

8. A package of sterile source materials, comprising:
a first component containing a hypochlorite or chlorite;
a second component containing an acid;
a single container holding the first component and the second component separately with a partition; and
a movable member which can move under application of an intentional force from outside the container,
wherein movement of the movable member permits the first component and the second component to merge and produce a sterile water in the container; and
wherein the first component and the second component are conditioned to assure that the sterile water produced by mixture thereof has a predetermined effective chlorine concentration and a pH level within the slightly acidic or neutral region.

9. The package of sterile source materials according to claim 8 wherein the movable member comprises a cutter capable of breaking the partition and permitting the first component and the second component to merge.

10. A package of sterile source materials comprising:
an outer container holding one of a first component containing a hypochlorite or chlorite or a second component containing an acid;
an inner container housed in the first container and holding the other of the first and second components;
a sealing member which seals the inner container; and
an operation member provided in association with the outer container and accessible from outside the outer container,
wherein manipulation of the operation member frees the inner container from the sealing member and permits the other component in the inner container to flow out into the outer container and produce a sterile water; and
wherein the first and second components are conditioned so that the sterile water produced by mixture thereof has a predetermined effective chlorine concentration and a pH level within the slightly acidic or neutral region.

11. The package of sterile source materials according to claim 10 wherein the operation member includes a seal cap for the outer container.

12. The package of sterile source materials according to claim 10 wherein the operation member comprises a pusher combined to the outer container and having a portion exposed outside the outer container.

13. The package of sterile source materials according to claim 10 wherein the outer container has a mouth; and the package of sterile source materials includes:
a circumferential sealing member provided inside the mouth;
a movable member having a circumferential recess sealed by the circumferential sealing member; and
a seal cap which closes the mouth,
wherein the circumferential recess comprises the inner container, and manipulation of the seal cap causes the movable member to fall, thereby release the circumferential recess from the seal member, and thereby permit the other component from the circumferential recess into the outer container.

14. A package of sterile source materials comprising:
an outer container holding one of a first component containing a hypochlorite or chlorite or a second component containing an acid;
an inner container housed in the first container and holding the other of the first and second components;
a plug in close fitting in an opening formed in the inner container to communicate with the internal space of the outer container,
an operation member associated with the plug and accessible from outside the outer container,
wherein intentional manipulation of the operation member causes the plug to get out of the opening of the inner container in response to movement of the operation member, and thereby permits the other component to flow out from the inner container into the outer container and to produce a sterile water; and
wherein the first and second components are conditioned so that the sterile water produced by mixture thereof has a predetermined effective chlorine concentration and a pH level within the slightly acidic or neutral region.

15. The package of sterile source materials according to claim 14 wherein the operation member includes a seal cap for the outer container.

16. A package of sterile source materials, comprising:
an outer container holding one of a first component containing a hypochlorite or chlorite and a second component containing an acid;
an inner container housed in the outer container and holding the other of the first component and the second component, said inner container being composed of a first member fixed to the outer container and a second member movable relative to the first member;
an operation member associated with the second member and accessible from outside the outer container;
wherein intentional manipulation of the operation member causes the second member to move and partly open the inner container and thereby permits the other component to flow out from the inner container into the outer container and to produce a sterile water; and
wherein the first and second components are conditioned so that the sterile water produced by mixture thereof has a predetermined effective chlorine concentration and a pH level within the slightly acidic or neutral region.

17. The package of sterile source materials according to claim 16 wherein the operation member includes a seal cap of the outer container.

18. A package of sterile source materials comprising:
an outer container having a mouth and holding one of a first component containing a hypochlorite or chlorite and a second component containing an acid;
an inner container having an upper end mouth opened upward and held in the outer container by engagement of the upper-end mouth with the mouth of the outer container, and holding the other of the first component and the second component; and
a seal cap closing the mouth of the outer container and closing the upper-end mouth of the inner container
wherein depression of the upper-end mouth of the inner container exposed by removal of the seal cap causes disengagement of the upper-end mouth of the inner container and the mouth of the outer container, thereby causes the inner container to drop into the outer container, and permits the other component to flow out of the inner container into the outer container and to produce a sterile water; and
wherein the first and second components are conditioned so that the sterile water produced by mixture thereof has a predetermined effective chlorine concentration and a pH level within the slightly acidic or neutral region.

19. The package of sterile source materials according to claim 18 wherein at least the upper-end mouth of the inner container is made of a soft material easily flexible with a finger force.

20. A package of sterile source materials comprising:
an outer container having a mouth and holding one of a first component containing a hypochlorite or chlorite and a second component containing an acid;
an inner container having an upper end mouth opened upward and held in the outer container by engagement of the upper-end mouth with the mouth of the outer container, and holding the other of the first component and the second component; and
a seal cap closing the mouth of the outer container and closing the upper-end mouth of the inner container
wherein a sterile water can be prepared by removing the seal cap, next removing the inner container out of the outer container, then pouring the other component from the inner container into the outer container; and
wherein the first and second components are conditioned so that the sterile water produced by mixture thereof has a predetermined effective chlorine concentration and a pH level within the slightly acidic or neutral region.

21. A sterile water preparation kit comprising:
a first container holding one of a first component containing hypochlorite or chlorite and a second component containing an acid;
a second container holding the other of the first and second components; and
an instruction manual having a description on quantities of the first component, quantities of the second component and quantities of the water to be mixed with the first and second components,
wherein the instruction manual guides a user to introduce the first and second components into a predetermined amount of water to produce a sterile water; and
wherein the first and second components are conditioned so that the sterile water produced by mixture thereof with the predetermined amount of water has a predetermined effective chlorine concentration and a pH level within the slightly acidic or neutral region.

22. A spatial sterilization apparatus comprising:
a supersonic generator for atomizing a sterile water containing hypochloric acid and having an effective chlorine concentration suitable for spatial sterilization and a pH level within the slightly acidic or neutral region;
an electric main fan for generating an air flow toward an open space; and
a second electric fan for carrying fog of atomized sterile water from the supersonic generator to the proximity of the main fan,
wherein the fog of the atomized sterile water is sprayed with the aid of the air flow generated by the main fan.

23. The spatial sterilization apparatus according to claim 22 further comprising a cartridge tank which can contain the sterile water containing hypochloric acid prepared by a user by mixing a first component and a second component, said first component containing a hypochlorite of a pre-adjusted concentration and contained in a first sealed space, and said second component containing an acid of a pre-adjusted concentration and contained in a second sealed space; and
wherein said supersonic generator atomizes the sterile water supplied from the cartridge tank.

24. The spatial sterilization apparatus according to claim 23 wherein the spatial sterilization apparatus is adaptive to receive the supply of the sterile water selectively from the cartridge tank or from an pipe arrangement.

25. A portable spatial sterilization apparatus comprising:
a cartridge tank which can contain a sterile water having an effective chlorine concentration suitable for spatial sterilization and a pH level within the slightly acidic or neutral region, said sterile water being prepared by a user by mixing a first component and a second component, said first component containing a hypochlorite of a pre-adjusted concentration and contained in a first sealed space, and said second component containing an acid of a pre-adjusted concentration and contained in a second sealed space;
a supersonic generator for atomizing the sterile water supplied from the cartridge tank;
an electric main fan for generating an air flow toward an open space; and
a second electric fan for carrying fog of atomized sterile water from the supersonic generator to the proximity of the main fan,
wherein the fog of the atomized sterile water is sprayed with the aid of the air flow generated by the main fan.

26. The portable spatial sterilization apparatus according to claim 25 wherein the sterile water having the effective chlorine concentration suitable for spatial sterilization is produced by diluting mixture of the first component and the second component with water upon or after mixture thereof.

27. The portable spatial sterilization apparatus according to claim 25 wherein the main fan and the second electric fan are a single common electric fan.

28. A spatial sterilization method comprising the steps of:
preparing a sterile water having an effective chlorine concentration suitable for spatial sterilization and a pH level within the slightly acidic or neutral region by a user's manipulation of mixing a first component and a second component, said first component containing a hypochlorite of a pre-adjusted concentration and contained in a first sealed space, and said second component containing an acid of a pre-adjusted concentration and contained in a second sealed space;
charging a tank with the sterile water prepared;
producing fog of sterile water by atomizing the sterile water supplied from the tank;
guiding a flow of the fog of the sterile water to the proximity of a main fan for generating an air flow toward an open space; and
spraying the flow of the fog of the sterile water guided to the main fan to a distance by using the air flow generated by the main fan as a carrier flow.

29. The spatial sterilization method according to claim 28 wherein water for dilution is added to mixture of the first component and the second component upon or after mixture thereof.
